(19) United States
(12) Patent Application Publication
(10) Pub. No.: US 2014/0149715 A1
(43) Pub. Date: May 29, 2014

(54) SCALABLE AND PROGRAMMABLE COMPUTER SYSTEMS

(71) Applicant: Los Alamos National Security, LLC, Los Alamos, NM (US)

(72) Inventor: Jeffrey Thornton Inman, Santa Fe, NM (US)

(73) Assignee: Los Alamos National Security, LLC, Los Alamos, NM (US)

(21) Appl. No.: 14/039,303

(22) Filed: Sep. 27, 2013

Related U.S. Application Data
(60) Provisional application No. 61/730,851, filed on Nov. 28, 2012.

(51) Int. Cl. G06F 9/38

(52) U.S. Cl. CPC G06F 9/3885
USPC 712/29

(57) ABSTRACT

Efficient, scalable, programmable, and reliable computing systems, built from a homogeneous set of relatively humble processors arranged logically or physically into a Recurrent Multi-Stage Interconnection Network (RMIN) is provided. The RMIN may include a plurality of layers, where each of the plurality of layers includes a plurality of nodes. The RMIN may also include a plurality of links configured to connect each of the plurality of layers, and a plurality of recurrent links configured to connect a plurality of nodes in a last layer of the plurality of layers to plurality nodes in a first layer of the plurality of layers. The plurality of links, together with the plurality of recurrent links, may be configured to allow data originating in any layer of the plurality of layers to pass through each of the plurality of layers without interruption.

### CROSS REFERENCE TO RELATED APPLICATIONS

This application is a non-provisional of U.S. Provisional Patent Application Ser. No. 61/730,851 filed on Nov. 28, 2012. The subject matter of the earlier filed provisional application is hereby incorporated by reference in its entirety.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD

The present invention generally relates to computer systems, and, more particularly, to scalable and programmable computer systems built from a homogeneous set of processors and arranged into a recurrent multistage interconnection network (RMIN), or the simulation or emulation of such an arrangement.

### BACKGROUND

Supercomputing technology is vital to the future of American scientific research, industrial development, and national security. However, state-of-the-art computing systems are inefficient, unreliable, difficult to program, and do not scale well. Furthermore, the trend appears to be toward technologies that will only increase these problems.

Many high-performance computers today are built around the highest performing processors, connected together through a multi-tiered all-to-all switch. These computers have state-of-the-art peak performance, but they typically deliver sustained performance far below their peak on real applications. This is because the computing capability of each processor is much greater than the bandwidth through the interconnect or memory, and most applications of interest require significant communication across the machine. The trend toward extending peak performance by adding multi-core accelerators, such as Graphics Processing Units (GPUs), exacerbates this problem by adding another layer of bandwidth bottlenecks, which programmers must accommodate by further fragmenting and specializing their applications. Optimization on these machines is therefore increasingly sophisticated, yet ad hoc, and some problems of interest continue to perform poorly on hybrid platforms despite optimization.

Furthermore, programming of these computers requires a complex mix of low-level techniques and languages, requiring considerable effort and expense. As such computing systems are scaled up, the maximum distance between components of the computing system becomes larger, so sensitivity to latency becomes more significant. In addition, at larger scales, the increased number of components results in increased likelihood of component failure. Because these computing system have no particular built-in robustness, they become more prone to failure of the entire system. This is addressed by periodically saving the state of the entire machine, but this is dependent on bandwidth, meaning that saving (and restoring this state) takes longer as computing systems get larger, further reducing the amount of time available for productive work. Finally, a significant amount of energy is wasted as heat, which requires additional energy to be used for cooling.

These issues result in supercomputers to be poorly utilized by many applications of interest, to not scale well, to be expensive to operate, to be vulnerable to component failures, and to be cumbersome to program. This means that a given supercomputer investment typically yields significantly less useful science or analysis than its peak performance would suggest. Thus, it may be beneficial to develop a scalable, efficient, reliable, and programmable supercomputer.

### SUMMARY

Certain embodiments of the present invention may provide solutions to the problems and needs in the art that have not yet been fully identified, appreciated, or solved by current supercomputing technology. For example, in some embodiments, efficient, scalable, programmable, and reliable computers, built from a homogeneous set of relatively-humble processors, are arranged into a RMIN. The addition of recurrent links between the top and bottom layers of nodes allows data originating in any of the node layers to be routed sequentially through all of the switching stages, albeit with different starting points. This arrangement allows for all of the stages of links to be used simultaneously, performing useful a routing technique, and moving of data from all of the layers concurrently. These techniques may also be applied in other embodiments which do not have the physical topology of an RMIN.

In one embodiment, a scalable apparatus is provided. The scalable apparatus includes a plurality of layers, where each of the plurality of layers includes a plurality of nodes. The scalable apparatus also includes a plurality of links configured to connect each of the plurality of layers, and a plurality of recurrent links configured to connect a plurality of nodes in a last layer of the plurality of layers to a plurality of nodes in a first layer of the plurality of layers. The plurality of recurrent links are configured to allow data to flow from the plurality of nodes in the last layer of the plurality of layers to the plurality nodes in the first layer of the plurality of layers.

In another embodiment, a node is provided. The node includes a plurality of input ports and a plurality of output ports. The node also includes a router configured to select a routing algorithm configured to move data elements from at least one of the plurality of input ports to at least one of the plurality of output ports based on identifying information related to a source node, within the context of a distributed routing operation designed to have a specific global effect.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a half of a butterfly MIN configured to perform programmed routing functions between nodes, resulting in a plurality of distributed global operators, according to an embodiment of the present invention.

FIG. 2 illustrates a three dimensional spatial arrangement of a butterfly MIN, according to an embodiment of the present invention.

FIG. 3 is related art illustrating an inefficient way to perform an operation on distributed data without the binary swap approach, using the butterfly MIN of FIG. 1.

FIGS. 4A and 4B are related art illustrating a binary swap algorithm using the butterfly MIN of FIG. 1, to operate on data originating from the top layer (L₁).

FIG. 5 illustrates a full duplex RMIN, according to an embodiment of the present invention.

FIG. 6 illustrates another full duplex RMIN, according to an embodiment of the present invention.

FIG. 7 illustrates a half-duplex RMIN, according to an embodiment of the present invention.

FIG. 8 illustrates another half-duplex RMIN, according to an embodiment of the present invention.

FIG. 9 illustrates an extension to the binary swap approach using the recurrent links in the RMIN of FIG. 5 to allow the operation to be performed efficiently on data originating in a middle layer, according to an embodiment of the present invention.

FIG. 10A is a diagram illustrating a router, according to an embodiment of the present invention.

FIG. 10B illustrates a 16-bit machine instruction for router algorithm programs, according to an embodiment of the present invention.

FIG. 11 is a circuit diagram illustrating a router processor using the machine instructions similar to that of FIG. 11B, according to an embodiment of the present invention.

FIG. 12 is a block diagram of a node architecture, according to an embodiment of the present invention.

FIG. 13 illustrates a graph generated from a dataflow analysis, according to an embodiment of the present invention.

FIG. 14 illustrates data structures to manage control of the router, compute fabric, and memory operations on a node, according to an embodiment of the present invention.

FIG. 15 is a circuit diagram of a compute fabric that may perform computations represented by some operator-nodes in the graph of FIG. 13, according to an embodiment of the present invention.

FIG. 16 illustrates an implementation of streaming memory such that delays are overlapped with data movement to allow continuous flow of data, according to an embodiment of the present invention.

FIG. 17 shows a logical view of an array and a physical arrangement of memory such that rows and columns can be accessed at the full bandwidth of memory by arranging activations of memory rows in the manner of FIG. 16, according to an embodiment of the present invention.

FIG. 18 is a block diagram illustrating a node, according to an embodiment of the present invention.

FIG. 19 illustrates a two-dimensional (2D) MIN containing nodes prior to transpose, according to an embodiment of the present invention.

FIG. 20 illustrates a 2D MIN containing nodes after transpose, according to an embodiment of the present invention.

### DETAILED DESCRIPTION OF THE EMBODIMENTS

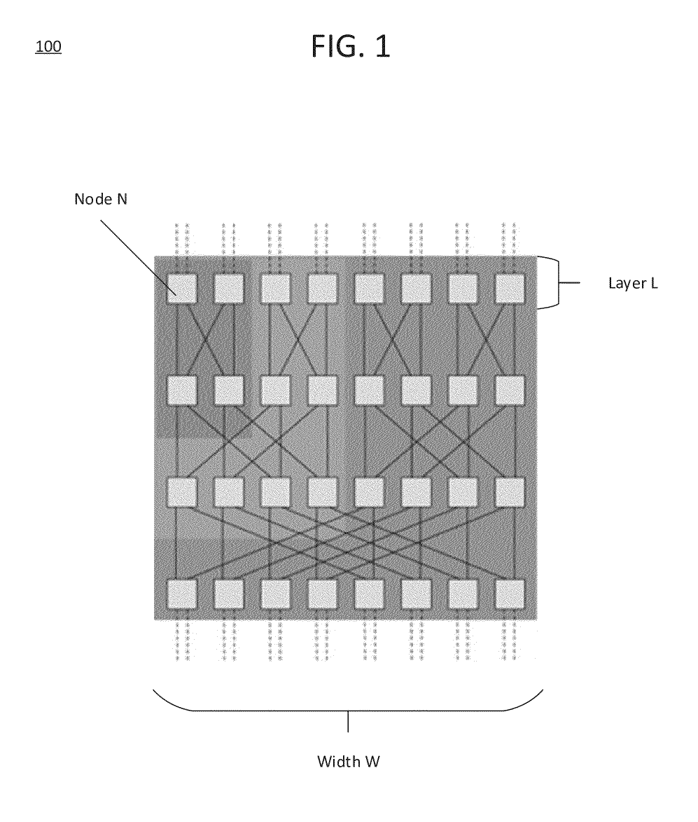

FIG. 1 illustrates a butterfly MIN 100 configured to perform routing functions between nodes. Butterfly MIN 100 is formed from a series of layers L of nodes N. Each node N has two ports facing a preceding layer and two ports facing a subsequent layer. In FIG. 1, counting the top layer first, there are L layers, and counting nodes N in each layer from left-to-right, the width of the layers is W. Each node N can be labeled according to its row and column, N[r, c], where r is the range [0, L −1], and c is in the range [0, W −1]. Except for the bottom layer, there are connections from N[r, c] to N[r+1, c] and from N[r, c] to N[r+1, (c−(cmodD))+((c+S)modD)], where S is 2ᵣ and D is 2^{r+1}.

Stated differently, each node N has two connections to nodes in the layer immediately below itself—one connection to the node directly below itself, and one to a node “diagonally” below itself. The diagonal destination node N is one column away when the source is in the top layer, two columns away for nodes N in the second layer down, four columns away in the layer below that, and so forth. Butterfly MIN 100 is arranged such that the column reached by the diagonal link is larger than that of the source if the source-column is even for nodes in the top layer, the source-column divided by two is even for nodes in the second layer, the source-column divided by four is even for nodes in the third layer, and so forth, where “division” implies the integer floor in the case where the division would otherwise produce a fractional value. Otherwise, the column reached by the diagonal link is smaller than that of the source by the same factors.

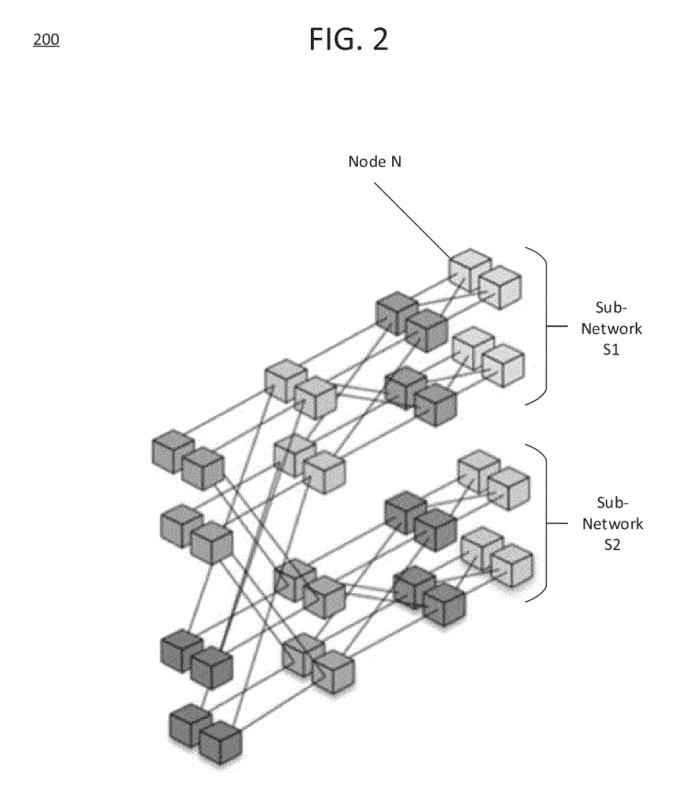

FIG. 2 illustrates a three dimensional spatial arrangement of a butterfly MIN with sub-networks of a top-level computing system, according to an embodiment of the present invention. In three dimensions, each “doubling” of the system size places two volumes containing sub-networks S1, S2 either side-by-side or one on top of the other, and adds a new plane of nodes, each of which makes connections to a node in the nearest layer of each sub-network S1, S2. The addition of each new layer may dictate the relative physical arrangement of sub-networks S1, S2 that it unifies. Successive layers may introduce their own spacing between sub-networks S1, S2 that the successive layers are joining. The successive layers may also dictate the spatial orientation of sub-networks S1, S2 in relation to each other, as well as the gaps introduced between nodes N in the newest layer and nodes N to which they connect. This allows the system to be designed so that air (or another cooling agent, such as water) can flow through the machine in a “scale-free” manner, and the spacing, orientation, and gaps introduced between sub-networks can be designed to allow adequate cooling for those sub-networks.

This recursive construction can be described in terms of, for example, a fractal Lindenmayer System. For instance, the spacing, orientation, and gaps that are introduced at each stage, as the size of the network is increased, are a function of the depth of the network. This function may allow the volume and flow of a cooling agent to remove the dissipated heat of the components, accounting for the heat that may be brought along to sub-networks S1, S2 as it is carried away from higher-order network layers. The spacing, orientation, and gaps introduced by newer layers could be larger or shaped differently, allowing greater volumes of the cooling agent to pass without increased resistance. The recursive nature of this structure can allow recursive construction processes to build such systems automatically (including through self-assembly) by matching new node components to previously-built sub-networks, resulting in the formation of new larger systems, which can then become components for the next-larger system, and so forth.

The shape of butterfly MIN 200 can also fan outward, up to a limit imposed by three-dimensional (3D) space, where nodes N of the lowest layer would collide with nodes N of another layer. In the interest of regularity and unlimited extensibility, a person of ordinary skill in the art may dispense with alterations in orientation in exchange for controls on spacing and/or gaps. It should be appreciated that without a scale-free physical structure, heat dissipated by nodes further from the exterior would tend to build up.

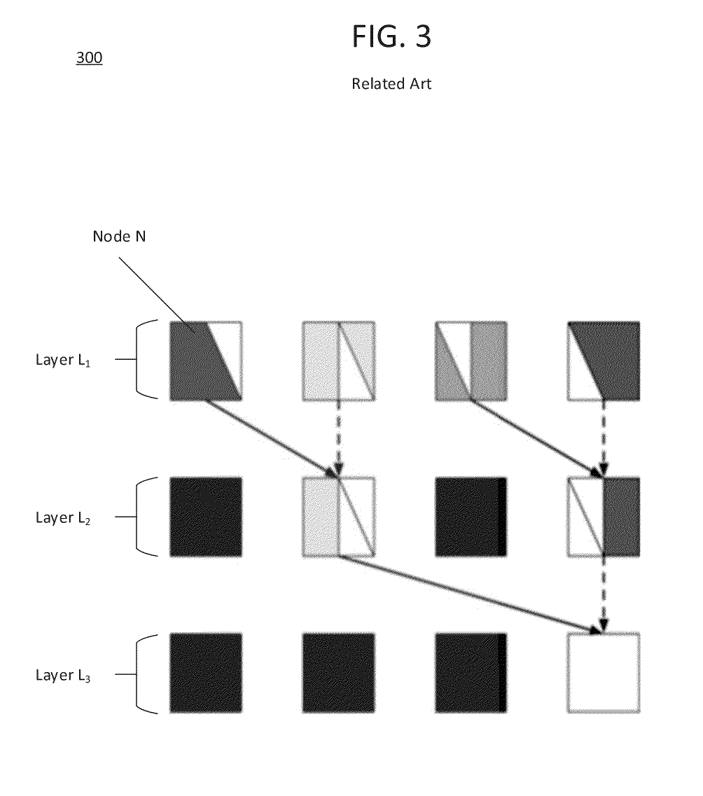

FIG. 3 is related art 300 illustrating an inefficient way to perform an operation on distributed data without the binary swap approach, using the butterfly MIN of FIG. 1. This example presumes that an image-compositing operation, in which the colors white, blue, green, yellow, red are respectively farther away. These colors may have been translated to grey-scale representations in FIG. 3. In the middle row (layer L₂), half of the nodes do work to combine two full-sized datasets. In the bottom row (layer L₃), a single node performs the work while the others wait. This algorithm does not make the best use of network or processor resources.

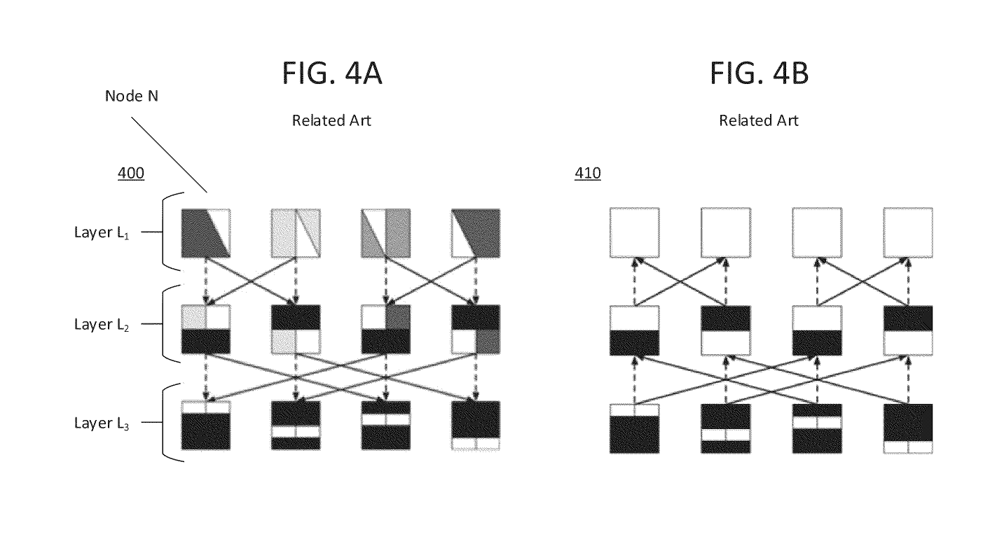

FIGS. 4A and 4B are an adaptation of related art illustrating a binary swap algorithm implemented using the butterfly MIN of FIG. 1 to operate on data originating from the top layer (L₁). In section 400 of FIG. 4A, pairs of nodes first share half of their local data (top set of arrows), and then work independently on two half-sized datasets. Next (bottom set of arrows), the pair of nodes share half of their half-sized datasets, and work independently on quarter-sized datasets. Finally (at layer L₃), each node N has ¼ of the final result dataset. In section 410 of FIG. 4B, the partial results are gathered together to form four copies of the final result, first moving quarter-sized datasets, then half-sized datasets.

In other words, the “scatter” phase of the binary swap algorithm shown in FIG. 4A divides the communication and computational work in half at each time step. This allows each pair of communicating nodes N to send only half of their local dataset, and allows each of those nodes N to remain active, working on the two corresponding smaller-sized datasets. This halving and sharing is repeated O(log n) times, where n is the number of nodes, until each node has 1/n of the final result dataset. The algorithm may then require O(log n) communication steps to reunite the fragments into the final result. The procedure is more economical than the one shown in FIG. 3, but still inefficient.

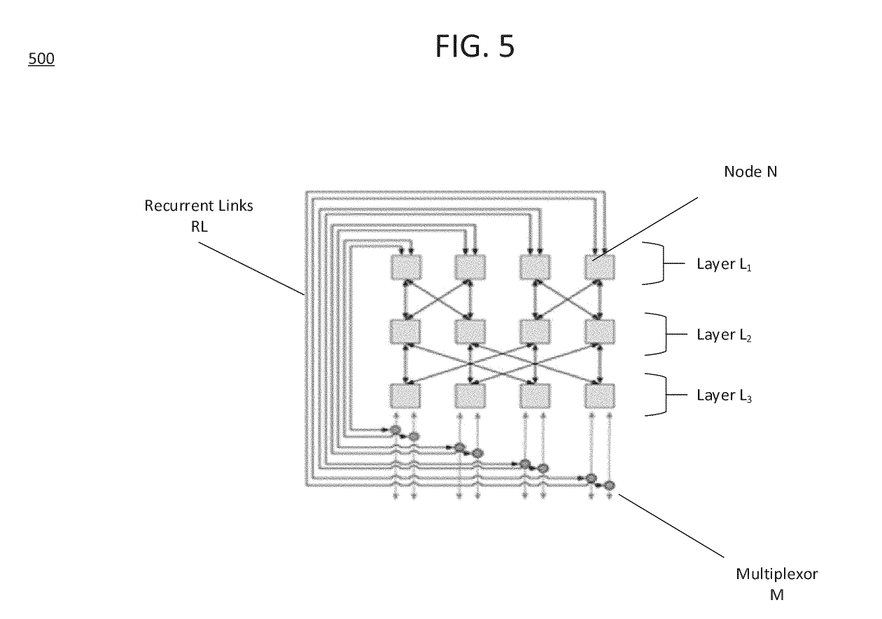

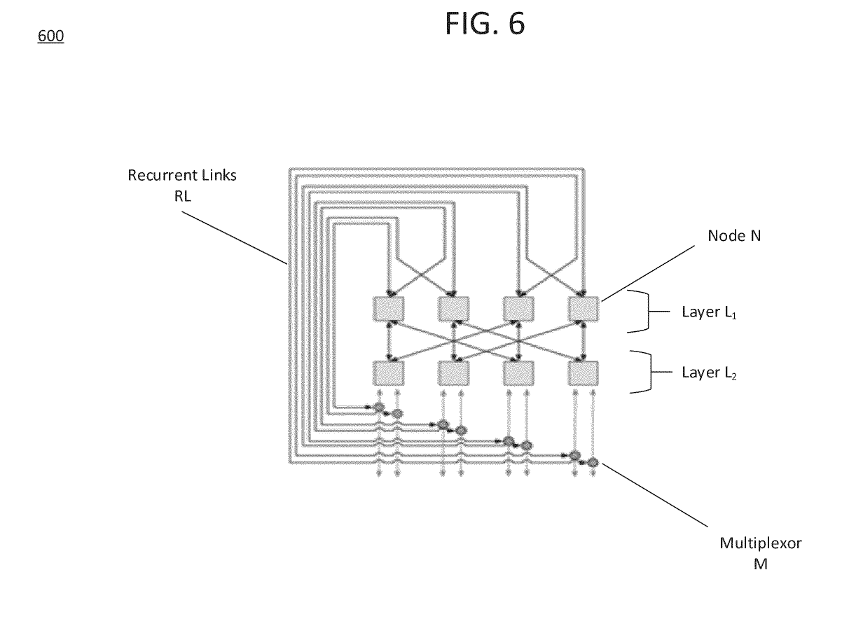

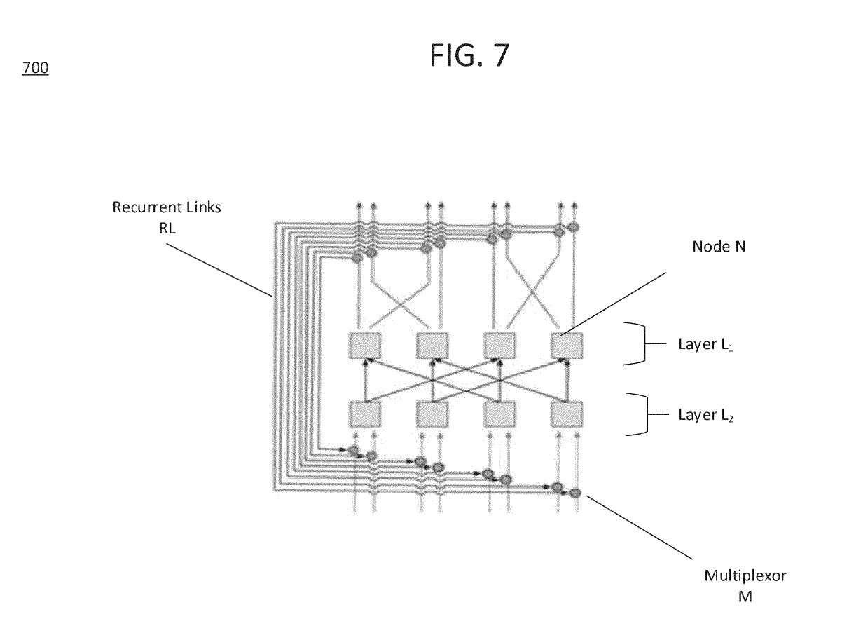

FIG. 5 illustrates a full duplex RMIN 500, according to an embodiment of the present invention. RMIN 500 includes a set of recurrent links RL from the output of the last layer L₃ to the input of the first layer L₁. It should be appreciated that an embodiment such as that shown in FIG. 2 could be implemented with recurrent links along-side the “straight” links, between successive layers, as a series of segments. This embodiment would allow a recurrent construction process to extend recurrent links with a new segment, at successive scales, instead of replacing or re-configuring recurrent links. Adding the recurrent links RL allows data to flow through all of the layers of nodes without revisiting any layer. Because the recurrent links RL do not perform a “routing” permutation function, a layer of nodes N in FIG. 5 can be removed. See, for example, FIG. 6. This has the benefit of allowing useful routing to be performed in every communication step, but may also require the bottom layer to perform additional work that could have been performed in the top layer in FIG. 5. FIG. 7 illustrates a half-duplex RMIN 700, according to an embodiment of the present invention, which may sometimes have construction or field-application benefits. Coordination of external I/O with traffic circulating on the recurrent links could be performed in units that have a function similar to an add-drop multiplexer. It should be appreciated that FIGS. 5-7 may include external I/O scaling in proportion to the width of a layer.

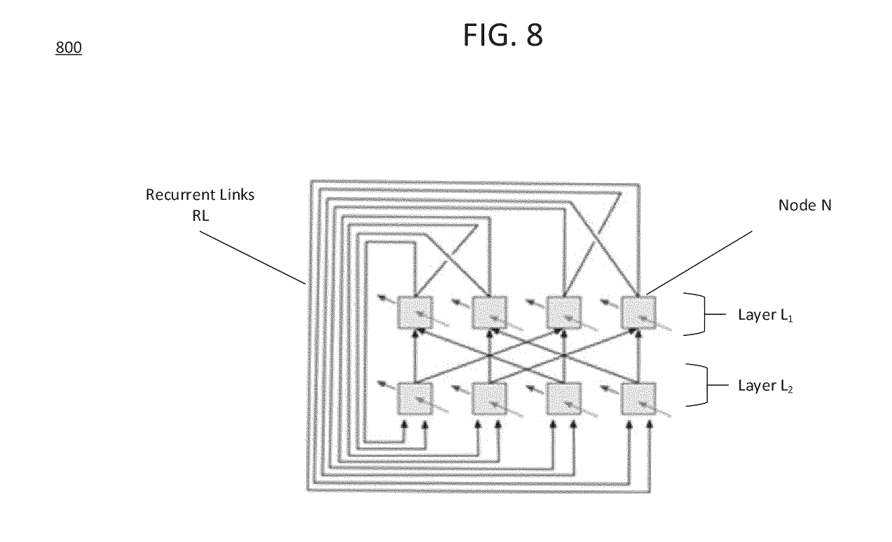

FIG. 8 illustrates a half duplex RMIN 800, according to an embodiment of the present invention. In this embodiment, a distinct communication “plane” is added at each node N for external I/O. This would allow external communication links to scale at O(n) with the network, where n is the number of nodes, instead of O(log n), as is the case in FIGS. 5-7. The increased volume of links in this configuration can be accommodated in the 3D packing of FIG. 2 by adjusting the fractal growth parameters discussed earlier, or their analogues, to add volume needed by links, leaving the required space for flow of a cooling agent. However, additional communication ports may be added at each node, and router behavior may now assimilate the orchestration of external communication with RMIN communication, formerly accomplished by the add-drop multiplexers of FIGS. 5-7. However, certain embodiments may not require additional time to handle such orchestration.

With the RMINs shown in FIGS. 5-8, the binary swap algorithm described above can be further extended to be more efficient. In particular, streaming data moved efficiently out of memory can be split into two output streams, for example, selecting the even-indexed values into one stream and the odd-indexed values into another. This avoids the need for buffers that would be needed to use a Store-And-Forward technique. Furthermore, concurrent operations that originated from any layer L₁ to L₃ can now run their scatter and gather phases to completion without interruptions. For example, the following equations illustrate the communication and computation used in a compositing operation on an image of size I:

$$\begin{matrix}communication\_volume = 2 {\sum }_{layer = 1}^{L} I ( {2}^{- layer} ) & ( 1 ) \\ composited\_pixels = {\sum }_{layer = 1}^{L} I ( {2}^{- layer} ) & ( 2 )\end{matrix}$$

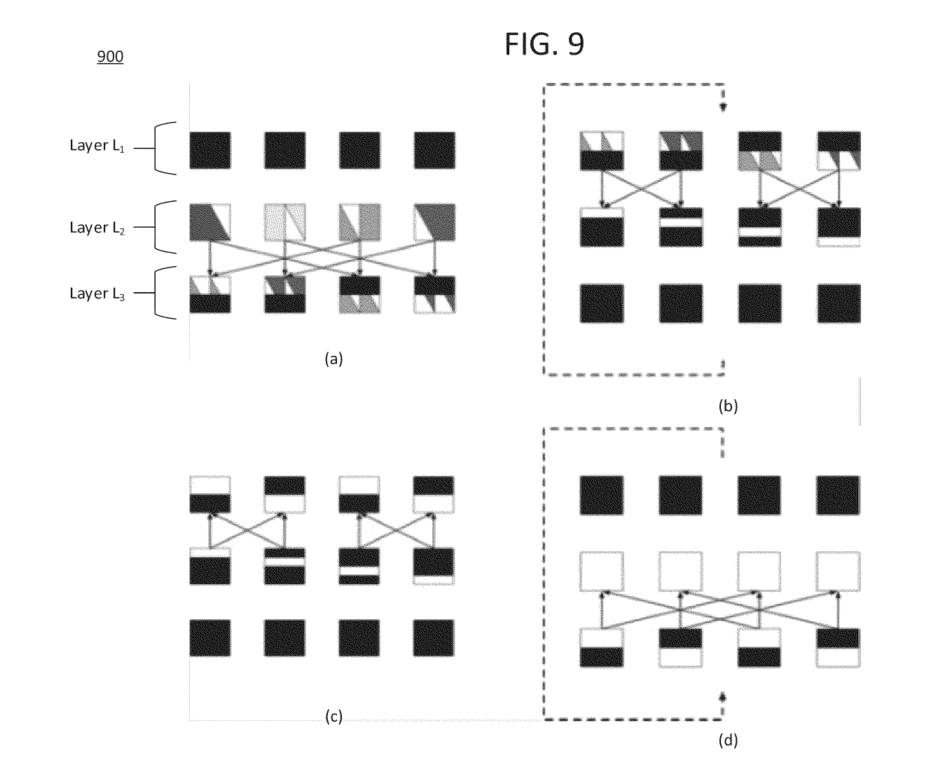

These equations allow compositing operations originating from any layer to achieve the same economy regarding data movement and computation. At every time step, the progress of scatters or gathers originating from all stages are all moving the same amount of data across some set of links, and/or performing the same amount of compositing. Furthermore, the scatters or gathers originating from any one stage (e.g., layer) are using links that are not used by the scatters or gathers of any other stage. There are also no delays where smaller volumes of data must wait for larger volumes of data to finish being transmitted, or where smaller-sized compositing operations must wait for larger compositing operations to complete. Given the same link-speed, gains in overall bandwidth in the full-duplex variants can be realized by overlapping scatter and gather operations, such that scatters circulate in one direction and gathers circulate in the other direction. See, for example, FIG. 9.

In this example, FIG. 9 illustrates an extended binary swap approach 900 using RMIN 500 of FIG. 5. In particular, sections (a) through (d) of FIG. 9 illustrates scatter and gather phases of extended binary swap approach 900. For example, the computation shown in FIGS. 4A and 4B can be performed with the same efficiency from an inner layer, making use of the recurrent links. With the addition of TDM-WR routing, as discussed below, or some other form of multiplexing, the operations of FIGS. 4A and 4B could run concurrently with the operations of FIG. 9. These operations could also run concurrently using Store-And-Forward routing, but this would typically require large temporary buffers, such that nodes could no longer maximize the use of their memory for local data. In addition, instead of moving blocks of data on the two output links, even and odd elements from a single stream can be separated to create the two output streams. This concurrent and streaming recasting of the algorithm in an RMIN can be called an “extended binary swap”. This formulation can be used to cast other data-parallel operators.

Time Division Multiplexed Wormhole Routing (TDM-WR)

For extended binary swap, the routing algorithm using a TDM-WR scheme is described in further detail below. The nodes N shown in FIG. 5 each have two ports at the top and two at the bottom. For purposes of a pseudo-code example, these can be referred to as the Top_{Left}, Top_{Right}, Bottom_{Left}, and Bottom_{Right}. The stream of data originating at the local layer can be referred to as Local(i), where i is the index starting at 0. Result(i) is the stream of final composited results, streaming consecutively into local storage. A slash (“/”) can be used to describe concurrent access to two different ports, with the understanding that such interactions stall until they can both complete. Turns can be taken as illustrated below, with time-steps indicated at the left, and corresponding actions to the right:

| | |
|---|---|
| t₁ | send next pairs of local data, receive local results (after 1^{st} |
| | iteration) |
| t_{2...L} | composite incoming pairs of non-local data, and forward |
| | results |
| t_{L+1...2L-2} | forward incoming pairs of non-local data |

### TDM Function Outline for Compositing Operator

The description of the scatter and gather phases can be separated for clarity, each represented in a manner like the TDM function shown above, in which each node's router takes “turns” managing data on behalf of different layers. In some embodiments, the scatter and gather algorithms could run concurrently, repeatedly executing the steps of their TDM functions, though the gather phase may not have inputs until after the first L “ticks” of the router algorithm clock, because that is the network latency of the scatter phase data. This analysis of number of steps in a router algorithm will be discussed in greater detail below to account for latency due to wire lengths. For the scatter-phase, the t₁ turn, which local data is injected onto output links, can be referred to as happening at t_{local}. Of the remaining L-1 turns, the first L-2 of these can be called t_{forward}, because those are steps the router is compositing and forwarding data that originated non-locally. The last L step of the scatter algorithm can be called tᵣₑᵥₑᵣₛₑ, because this represents data that was injected by its own layer, which has gone through all L stages of scatter (and composite), and is at the point at which scatter turns around to become gather. Similarly, the gather phase has forwarding steps to handle composited results from other layers, until composited results arrive at its own layer. The result is shown below:

### RMIN Routing Algorithm for Scatter Phase of a Compositing Operator

| | | |
|---|---|---|
| t_{local} | Send Local(i)/Local(i+1) | on Bottom_{Left} /Bottom_{Right} |
| | Send Local(i+2)/Local(i+3) | on Bottom_{Left} /Bottom_{Right} |
| t_{forward} | Recv Top_{Left} / Top_{Right} | push as operands Op₁/Op₂ |

for Composite (result = R₁)

Recv Top_{Left}/ Top_{Right} push as operands Op₁/Op₂ for

Composite (result = R₂)

If (2 composite results available)

| pop R₁/R₂ | |
|---|---|
| Send R₁/R₂ | on Bottom_{Left} / Bottom_{Right} |

| | | |
|---|---|---|
| tᵣₑᵥₑᵣₛₑ | Recv Top_{Left} / Top_{Right} | push as operands A/B for |
| | | Composite |

Recv Top_{Left}/ Top_{Right} push as operands A/B for
Composite
If (2 composite results available)

| pop R₁/R₂ | |
|---|---|
| Send R₁/R₂ | on Top_{Left} /Top_{Right} |
| Send R₂/R₁ | on Top_{Left} /Top_{Right} |

### RMIN Routing Algorithm for Gather Phase of a Compositing Operator

| | | |
|---|---|---|
| t_{gather} | Recv Bottom_{Left} / Bottom_{Right} | Send on Top_{Left} / Top_{Right} |
| | | Send on Top_{Right} / Top_{Left} |
| t_{local} | Recv Bottom_{Left} / Bottom_{Right} | Write as Result(i)/Result(i+1) |

The algorithm has different behaviors at different time-steps, corresponding to cases in which there is local data or forwarding of remote data, and for how far away (in layers) that data originated. It should be noted that the distance to the layer from which the data originated can be determined using the time-step in which it is received—no other data is needed. It should also be noted that tᵣₑᵥₑᵣₛₑ and t_{local} in the scatter algorithm may overlap, due to the use of opposite network links. Also, the reception of results at t_{local} at the end of the gather phase (e.g. top row of FIG. 4B) can be overlapped with t_{local} at the beginning of the scatter phase, because they use different directions on the same links. Numerous other adjustments are possible.

Some latency can be allowed for in the composite operator by imagining a first pass where operands are queued for compositing, such that results could be available during subsequent passes. The details of first in, first out (FIFO) queue size for the hardware performing the composite operation can be ignored, for this example. Each time-step may have two actions, corresponding to the two instruction-halves in the embodiment under consideration.

In the example shown above, RMIN routing for the scatter-phase of the extended binary swap algorithm uses TDM-WR on the “downward” links of FIG. 5. This TDM-WR approach requires no additional buffering of data streams being forwarded, at arbitrary scales, allowing local data to be produced as a single stream, and requiring that stream be produced at 2/L the bandwidth of the network. Network bandwidth could be increased in some embodiments by adding additional links parallel to the existing links, and increasing the router speed, or breaking router operations up into parallel tasks. For example, the same router algorithm may be executed on parallel links. In some cases, this would increase the bandwidth needed for interactions with local memory by the number of parallel links added. It should be appreciated that routing in TDM-WR, and other multiplexed regimes, does not explicitly require examination of packet headers, or analysis of protocols, allowing routing to be performed deterministically and quickly.

The RMIN routing shown above for the gather phase of the extended binary swap algorithm uses TDM-WR on the “upward” links of FIG. 5. t_{gather} includes all of the network steps except for t_{local} because the gather phase does not have a direction-reversing aspect. It should be appreciated that in some embodiments, gather operations and scatter operations may proceed concurrently.

It should also be appreciated that routing behavior may be governed by a counter. At system initialization, nodes may discover the value of L (i.e., the number of node layers in the computing system), and use this to drive the TDM-WR algorithms, such as that shown above. The gather phase need not become active until the counter is greater than or equal to L. One of ordinary skill in the art may understand that router programs may concurrently pull values from both ports and place the values somewhere else (i.e., local(i) and local(i+1) can be placed onto output ports concurrently), two port values may be moved to result(i) and result(i+1) concurrently, two compositing operands (or results) can be pushed (or popped) concurrently, input and output ports can be used concurrently, etc. The TDM-WR algorithms may presume a stall when two concurrent inputs needed at any point are not available. A premise can be added that a small FIFO of at least two elements is associated with each port (for each direction, in the full-duplex case), though the term FIFO is a misnomer in terms of the inputs, where the receiving communication hardware does push values into these slots in first-in-first-out order, but the router instructions can read from these slots in other orders, as described below. Dynamic router state (e.g., not including static router-algorithm instructions, or dispatch tables, or values initialized at start-up for use by router algorithms) could include the following: router-algorithm counter, computation state, contents of the port queues, current operator(s), and current memory location(s).

In some embodiments, ongoing operators can be allowed to be “swapped” in and out, in the manner of a context switch in a computer operating system. Such swaps may have to be statically scheduled, or preceded by a pipeline-clearing distributed control message (with latency) to coordinate the swap. In some embodiment, the swap may be handled by adding a capability for selection among redundant implementations of control hardware, in a manner analogous to methods used by processors that utilize extra hardware to support low-latency context-switches, and so forth. It can be presumed that some one-cycle operations, such as swapping of left and right, can be performed by the router by simply selecting among multiplexed data paths, etc., as discussed below. Regarding the allowance for latency in the composite operator, in the scatter phase of the composite operation, it should not matter whether results coming from the composite are matched with the same data that is being received during the t_{forward} period of the router behavior. Thus, the algorithm should not have to wait for the results to begin to appear. Alternatively, the first L cycles of the router behavior could be implemented by a distinct program, which did not expect compositing results to be available, switching then to another program, which would wait for local compositing results at the appropriate step.

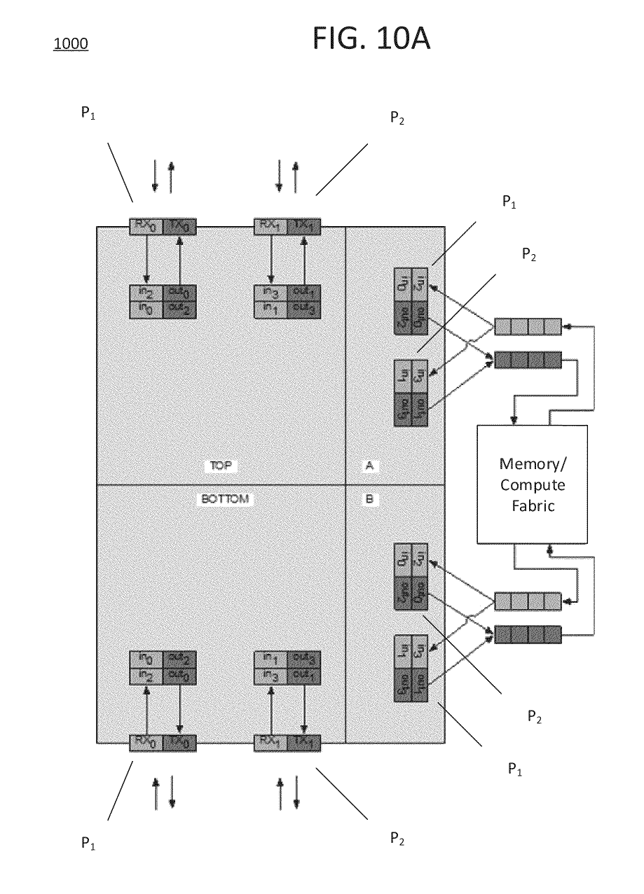

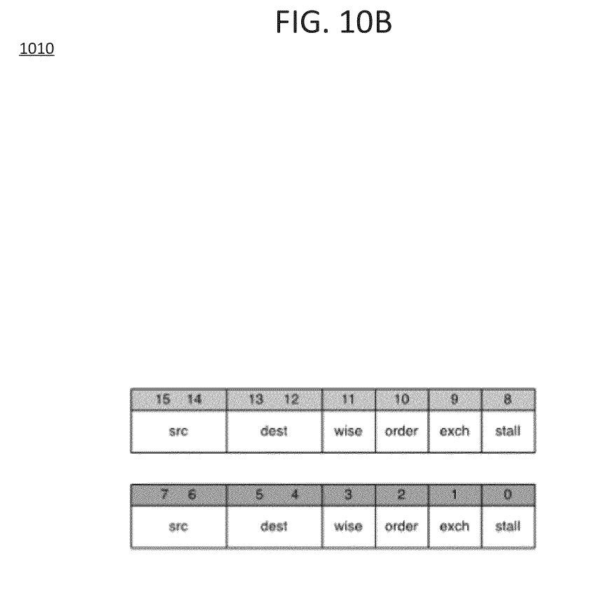

FIG. 10A is a diagram illustrating a router 1000, according to an embodiment of the present invention. Router 1000 includes four possible source and destination port groups, i.e., TOP, BOTTOM, A, and B. Port group A includes two ports P1, P2, and port group B includes two ports P1, P2. Both port groups A and B interface with, and connect to, memory (or computer fabric) 1005. The TOP port group includes two ports P1, P2 and the BOTTOM port group includes two ports P1, P2. Each port has a FIFO queue of depth 2 for reception and another FIFO queue for transmission. The designation of “input” and “output” is from the perspective of the router. The term “port” may be used herein to refer to a port group. Similarly, the input or output FIFOs for the two ports in a port-group may be referred to as a single, combined, two-wide, two-deep FIFO, or queue, representing inputs or outputs for the combined FIFO queues on the ports of a port group. The communication channels and values in the send/receive FIFO queues may include extra bits, in addition to the data, allowing for Out-Of-Band communication or representation of not-a-value values.

Each receive FIFO queue may allow access to all four positions, but the transmission queues may be operated in strictly FIFO order. The source/destination ports marked port A and port B in FIG. 10A connect to local FIFOs. These local FIFOs may connect directly to memory and/or to a compute fabric 1005. This allows router algorithms to perform arbitrary computations. For example, the router may place values received from the interconnect onto outputs of port B, where local streaming computation then produces output values back onto the inputs of port B. These values can then be placed back onto the interconnect. In this example, port A would remain available to move local values between memory and the interconnect. A person of ordinary skill in the art would readily appreciate that the router algorithm described above may be implemented this way, using the compute fabric 1005 to perform a compositing operation. However, it may be preferable to give the router its own compute resources in order to isolate router state, or optimize special operations.

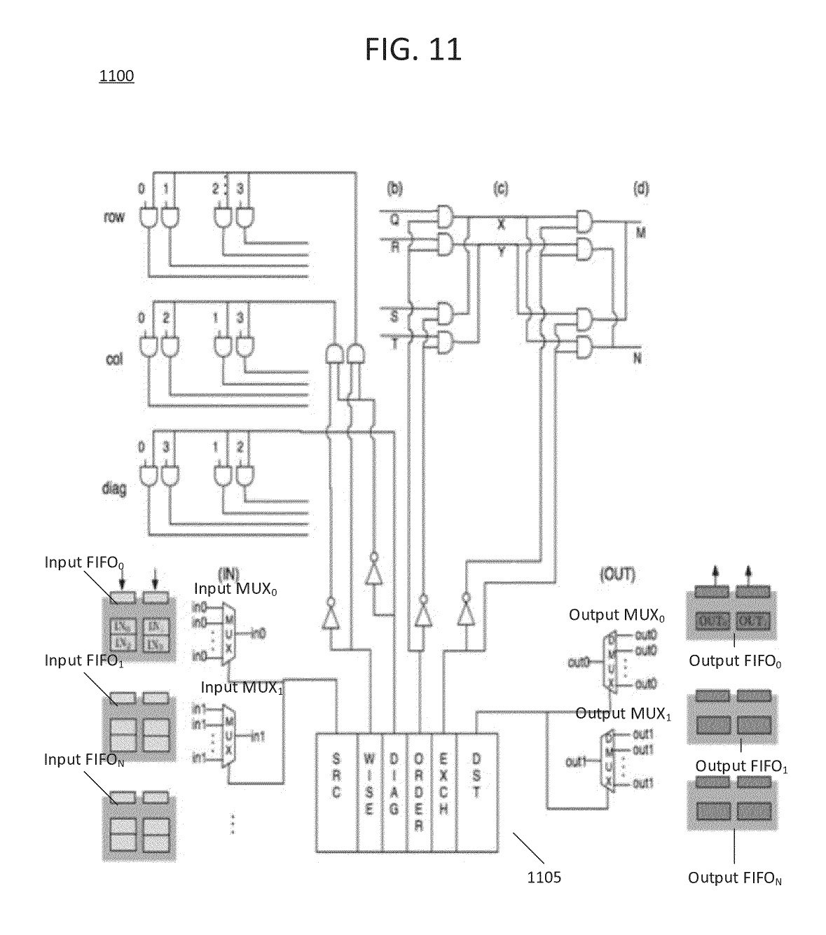

FIG. 10B illustrates a 16-bit machine instruction 1010 for router algorithm programs, according to an embodiment of the present invention. In this embodiment, 16-bit machine instruction 1010 defines movement of four operands from an in-port group to an out-port group in FIG. 10A. WISE and ORDER in each sub-instruction combine to identify two operands out of the 4-values at the front of the input FIFO queues on the source port group. Two bit-positions in the SRC and DST fields suggests that this embodiment may include four port groups that can be designated as inputs or outputs. It should be appreciated that a diagonal pair may not need to be selected from the input port if send order can be adjusted to place values in the same row or column of inputs. However, FIG. 11 shows an alternative circuit diagram 1100 in which selection of diagonal values is supported, because adjusting send order may sometimes be inefficient or impossible. By ruling out certain source/destination pairs, additional representations may be captured. One skilled in the art would readily appreciate that some combination of bits that is ruled out, as described above, may represent a trigger that causes all the other bits to be interpreted differently, allowing representation of control instructions, special values, or meta instructions, such as NO-OP, REPEAT, etc., referenced below.

A router algorithm counter may be implemented as a program counter for executing router microcode. Each half of the instruction in FIG. 10B operates on one input pair. This allows data to move from interconnect to the compute fabric and from the compute fabric to interconnect in the same algorithm step, as in step t_{forward}. A no operation (NO-OP) can be used in the second half of an instruction for algorithm steps requiring only one operation per instruction.

The two half-instructions, or in general multiple simple instructions, may co-issue, such that four inputs are moved to four outputs concurrently for a multiplicity of non-conflicting pairs of port groups. The permutation of the inputs, which affects some or all of the switching functions performed by the router, is done in this case by allowing selection of two out of the four possible inputs for output. The outputs, produced by each half instruction, are then delivered to the output port in regular order, such that the two inputs selected by the first half-instruction become the first pair of outputs, and the pair of inputs selected by the second half-instruction become the second pair of outputs, where a pair of outputs implies outputs directed to the two different transmit queues on the selected port.

In general, an embodiment may concurrently issue a multiplicity of router instructions (or “half-instructions”) that do not conflict. For example, in an embodiment such as that shown in FIG. 10A, a router could, without conflict, simultaneously move both pairs of inputs from TOP to A, from A to TOP, from BOTTOM to B, and from B to BOTTOM. This could represent the combined actions of a single distributed operator, or the simultaneous execution of two or more different distributed operators. It should be appreciated that this provides an opportunity for a task scheduler to dynamically discover simultaneously-runnable router tasks, which could then be co-issued on embodiments that made this possible. Thus, two or more router operations that were simultaneously runnable, and did not have conflicting ports, could run concurrently.

Furthermore, the process to load a program and to identify the FIFO queues that will be used could also identify opportunities for such co-issued operations, and select or change port group assignments to make this possible for the task scheduler. For example, given two distributed operations that would use port group A, it could be possible to transform one of them to use port group B instead, enabling the two operations to be co-issued. This may be further supported by allowing router operations to abstract away the specific port group used internally (e.g., A or B), and have this destination provided in a register by a task scheduler. This would allow port group reassignments to be done easily and dynamically, as the opportunity arose, rather than having to be discovered analytically and/or enabled through code rewriting.

Where a machine has L layers and O distributed operators, the router in each node can be expected to have approximately O different algorithms with generally no more than L instructions each (or 2L if scatter/gather phases are needed). Because many steps are repeated in typical algorithms, a short REPEAT instruction with a repeat-count that allows some instructions to be consolidated may be employed.

In order to abstract away the specific size of the computing system being targeted by an algorithm, the language that is used to write router algorithms may allow steps to be expressed in terms of layer L, width W, and/or the column and/or layer of the node on which they execute. Such code may appear conditional, but can support generation of non-conditional microcode for each specific node. Many router algorithms can be expressed in terms of the bit position that is effectively being switched by the next layer of links. In other words, in the butterfly MIN pattern, each pair of output links connects to a node in the same column and to one which is in a column number that differs by one bit. Some algorithms, such as a radix sort, exploit this property, and others are at least easier to express in these terms. Code may be conveniently written in general terms to appear conditioned on these values. However, this code may then be compiled into unconditional code that is different for the router on each node, or on groups of nodes. See, for example, the micro-code shown below. This node-specific code can then be loaded into the proper nodes with a distributed LOAD operation developed for that purpose.

Furthermore, the router may be extended to use registers that hold values pertinent to the size of the computing system. These registers could be initialized at start-up by means of a special purpose distributed operation. This may determine values such as the number of layer L, width W, column c, and/or row r, referred to in the router programs. These registers could then be used in relation to simple loop counters, allowing groups of steps to be abstracted in the router code. For example, steps referred to as “t_{forward}”, above, could be iterated the proper number of times for a computing system of a given size, rather than having to be compiled into code with a fixed number of operations, and recompiled when the size of the targeted system changes. This could be accomplished by using the REPEAT instruction described above, controlled via a register that is initialized to the proper value. A counter may iterate until the value matches the indicated register, and then reset and advance the program counter.

FIG. 11 is a circuit diagram 1100 illustrating a router processor, according to an embodiment of the present invention. The router processor includes router instructions 1105, which are similar to the instructions shown in FIG. 10B.

In this embodiment, the router processor of FIG. 11 utilizes input multiplexors MUX₀ to MUX₃. The bits in source SRC are fed to the select gate of input multiplexers MUX₁ to MUX_{N}. Input multiplexors MUX₀ to MUX₃ identify which port group is to be used, and produce respective lines corresponding to the four spots of input FIFO₀ queue on that port group. The outputs from the four inputs multiplexers connect directly (not shown) to the AND gates of all three of the permutation control circuits, designated ROW, COL, and DIAG. For example, the AND gates in the permutation circuit marked COL receive in₀, in₂, in₁ and in₄, respectively, which correspond to a column-wise view of input FIFO queues on the port group selected by source SRC. The three permutation control circuits each have four output wires connected directly (not shown) from top-to-bottom, respectively, with the wires marked Q, R, S, and T. The bits in WISE and DIAG control AND gates to select the desired permutation circuit, such that wires Q, R, S, and T receive the inputs in row-wise, column-wise, or diagonal-wise ordering.

The instruction bit marked ORDER then selects either the high-order or low-order pair, from the four values on Q, R, S, and T, to become values at X and Y. The exchange EXCH bit then controls whether these values are swapped or fed through as-is, to become the values at M and N. Finally, the bits in destination DST select the destination port group, via output multiplexers, Output MUX₀ and Output MUX₁. The output multiplexers work in a way complimentary to that of the input-multiplexers, such that the values at M and N are placed into OUT₀ and OUT₁ of the output FIFO queues (FIFO₀, FIFO₁, through FIFO_{N}), on the selected output port group. For simplicity, only two output values are shown in this embodiment because the instruction does not need to select among the four values in the FIFO queues of the output port group. Instead, the first half-instruction is presumed to write to the first-to-transmit values in the output port group, while the second-half instruction writes to the second-to-transmit pair, unless first half instructions and second half instructions refer to different port groups, in which case the second half-instruction writes to the first-to-transmit pair. In this embodiment, all direct switching is performed via permutations of the four values at the end of the pair of input FIFOs in the selected port group. Further permutations could be accomplished indirectly via collaboration between distributed operations through the router and local operations in the compute fabric, as discussed below.

In certain embodiments, operators may be created for an existing computing system, such that router operations can be controlled by software or microcode. Operators may be written in an operator-language that allows specification of router behavior in a series of time-steps (i.e., for TDM-WR), or some other process to identify the source layer of the data or pertinent information. The operator-language may then correlate the pertinent information with appropriate router functions. For example, other forms of multiplexing may use techniques other than time slots to distinguish channels representing data coming from parts of the network to which specific routing functions are to be applied. Programs in such an operator-language would be compiled into router microcode (instructions), and loaded via a distributed operator supplied for that purpose. These operators could then be accessed like any other operator, through a high-level programming language, such as the ones used in the examples herein. To allow access to new operators, such high-level languages may allow reference to operators that are not known to the compiler. The linking of compiled high-level programs to such new operators could be as simple as referring to a router program by some identifier known to the programmer, or installed as a table used by the compiler, which would allow the executive to associate the new router program with that block in the compiled dataflow graph (DFG). An example of the left-shift operator written in a hypothetical version of such a language is shown below. The LSHIFT operator is also discussed in detail later.

// Supposing two router half-instruction per time-step.
// Built-in variables for port-groups include:
// RMIN width and height (in nodes), Node row and column, etc.
// Generate a different program for every column and row.
define 1shift { // router-code for a LEFT-SHIFT operator

| // --- scatter-phase on downward links | | |
|---|---|---|
| t(0) | { top = local(0,1,2,3); } | // send local operands |
| t(1) | { top = bottom(0,1,2,3); } | |
| t(2, height−2) | { top = bottom(0,1,2,3); } | |
| t(height−1) | { if ((col % (width / row)) < 4) { | // begin gather |

| | |
|---|---|
| bottom = bottom(0,1,2,3); | // (swizzle) |

else

bottom = bottom(0,1,2,3); } }

| // --- gather-phase on upward links | |
|---|---|
| t(0, height−3) | { if ((col % (width / row)) < 4) { |

| | |
|---|---|
| bottom = top(0,1,2,3); | // (swizzle) |

else

bottom = top(0,1,2,3); } }

| t(height−2) | { bottom = top(0,1,2,3); } | |
|---|---|---|
| t(height−1) | { local = top(0,1,2,3); } | // recv local results |

}

In the example of a language for writing router operators shown above, port groups from FIG. 10A are referred to by name. On the left, router time-steps, or ranges of time-steps, are given. These ranges can be abstracted based on the height of the RMIN (e.g., L) or other factors. On the right of each assignment, input values are selected in a permuted order from the four positions of the 2×2 set of input FIFO queue positions on the designated port group, and assigned in that order to the four output positions in the designated output port group. For example, “DST=SRC(0,1,3,2)” would indicate that the first half-instruction reads in₀/in₁ (i.e., row-wise) from the 4 values of input port group SRC, and writes these values to the first-to-transmit output FIFO queue positions in port group DST, while the second half-instruction reads in₂/in₃ (i.e., row-wise) from input port group SRC, exchanges the position of values in the pair, and writes the resulting pair to the second-to-transmit output FIFO queue positions in output port group DST. One skilled in the art will readily appreciate how the statements in this program could be transformed into the router instructions described earlier, and how in some embodiments the conditional statements in the scatter and gather phases could be replaced with appropriate instructions such that the resulting code is a complete set of unconditional instructions for the router of any specific node. Furthermore, in some embodiments, the statements that imply the same actions taken for a range of time-steps could be reduced to a built-in loop, using a REPEAT instruction as described above.

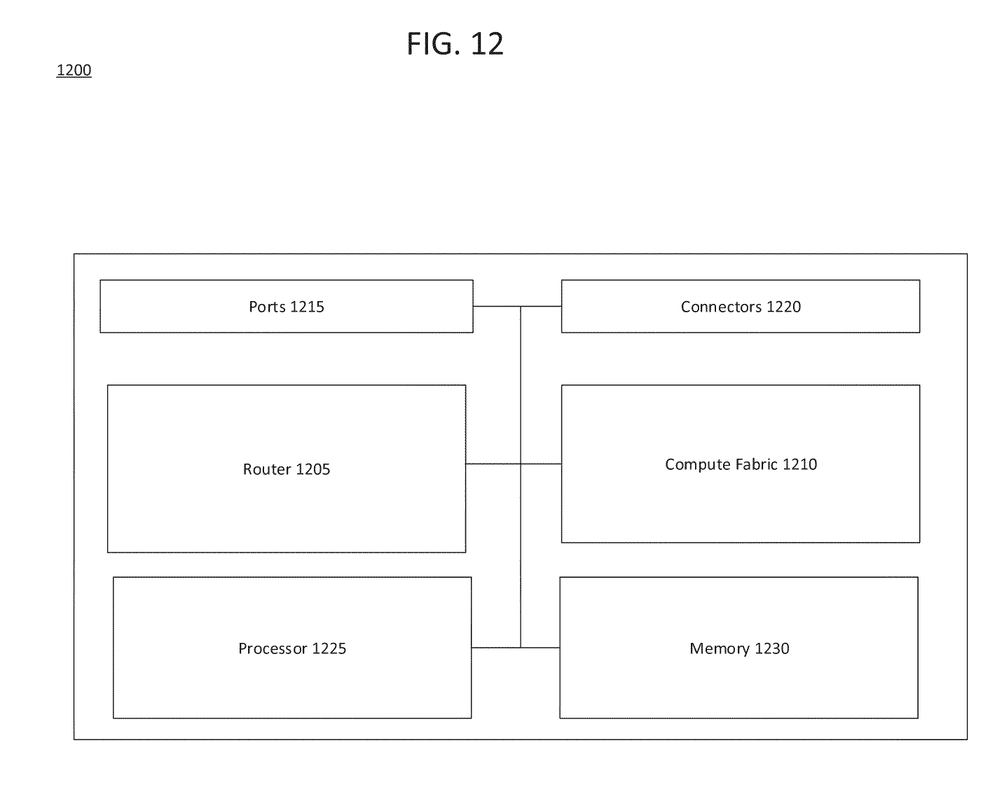

FIG. 12 is a block diagram 1200 of a node architecture, according to an embodiment of the present invention. As shown in FIG. 5, a network may include a plurality of nodes. Each node may route data and perform local computation in a stream-processing, dataflow regime. The node is designed to provide a scalable component that can be stacked as shown in FIG. 2. The node provides processing capabilities with memory bandwidth and interconnect bandwidth maximizing utilization and throughput.

The node is configured to unite several distinct subsystems—a router 1205 and a compute fabric 1210. Router 1205 may handle data arriving at and leaving the node through interconnect ports 1215, and compute fabric 1210 handles computation. The functionality of the router has been described above with respect to FIG. 10A. Ports 1215 and connectors 1220 allow the node to be integrated via the router interface with other nodes.

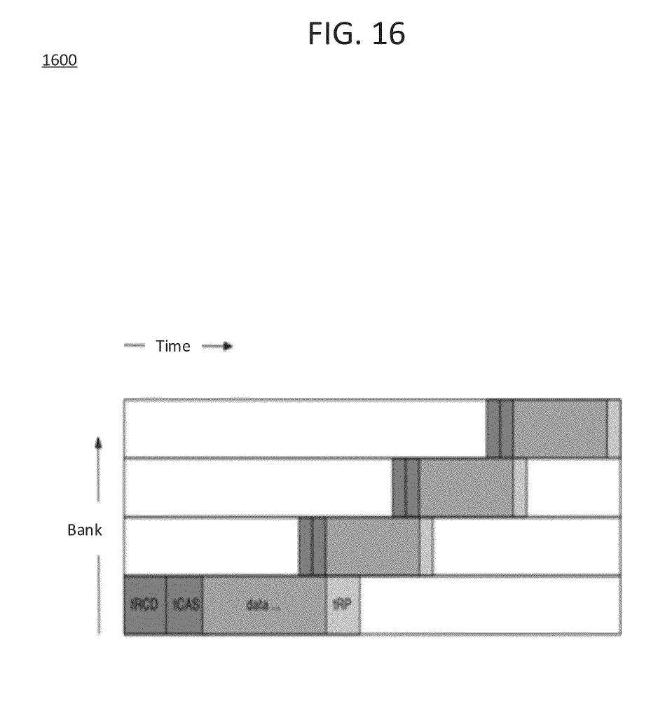

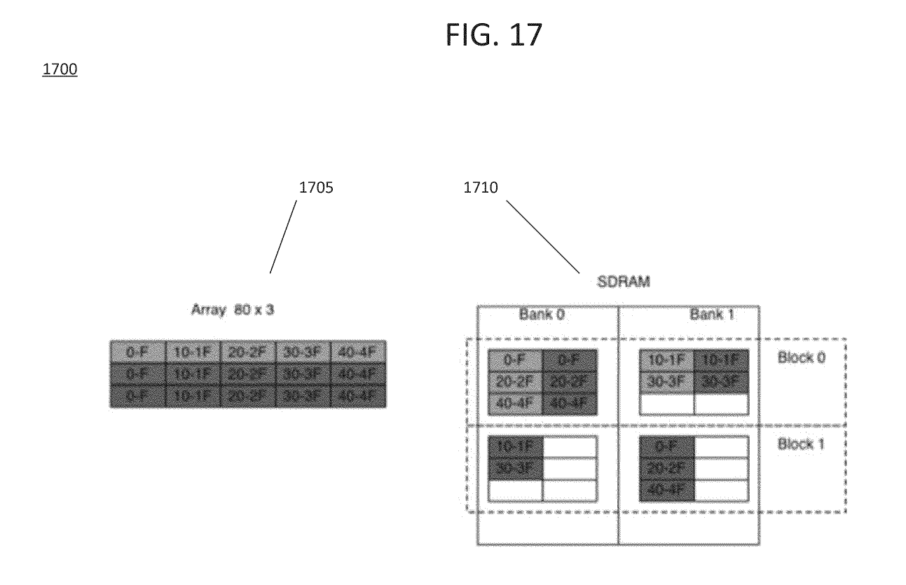

Compute fabric 1210 is connected by FIFO queues that may be sized to accommodate an integral number of “memory flits”. This means some or all of the FIFO queues may be sized in relation to the maximum amount of memory 1230 that is read from/written to a single physical row of memory so as to support the streaming memory layout and access techniques discussed, for example, with respect to FIGS. 16 and 17. In some embodiments, there can be room in each FIFO queue for at least two times the expected storage, so the FIFO can be “double-buffered”. For example, while one FIFO buffer is being consumed, there is room in another FIFO buffer to be written. In the case of FIFO queues sized to hold “memory flits” for efficient interaction with memory, while one flit is being moved into memory 1230, there is still room for other values to be added to the FIFO queue. This would allow DMA processes requiring a known amount of storage to assure that this storage was available before starting, and to avoid the need to manage locks during execution of the DMA processes.

A data-parallel program may be loaded in memory 1230 and operated within each node. In one embodiment, a “control plane” can be created, distinct from a “data plane” by adding a line to the data-path identifying control messages, by adding a bit to message headers in systems implemented via packets, or by adding one or more distinct multiplexed channels in TDM. It should be appreciated that other techniques may be used to add the control plane. A control message may place the node into a “loading” state. Subsequent data on the datapath may be treated as program data to be loaded into program memory (not shown). Static data can be loaded by similar means. The loaded data could arrive initially at a single layer (as shown in FIGS. 5-7), could arrive initially at all nodes (as shown in FIG. 8), or at a single node. The loaded data can then be spread to other nodes, if needed, via one or more SHIFT operations, or other distributed operations. New router microcode may be loaded by a similar technique to be stored in memory 1230 on each node, and/or transferred into program memory on the router.

It should be appreciated that in certain embodiments, programs that run in a RMIN involve global data that is distributed throughout the nodes of the RMIN. The programs are operated by a combination of local (per-node) and distributed (pan-machine) operators. These programs can be concise because the programmer does not have to develop efficient data movement techniques, relying instead on the operators. The programs devolve to an ordered set of invocations of pre-loaded operators, as will be discussed later. The operators may be micro-coded or laid out in hardware and invoked as a single program operation with given operands. The node is configured to orchestrate the execution of these operators.

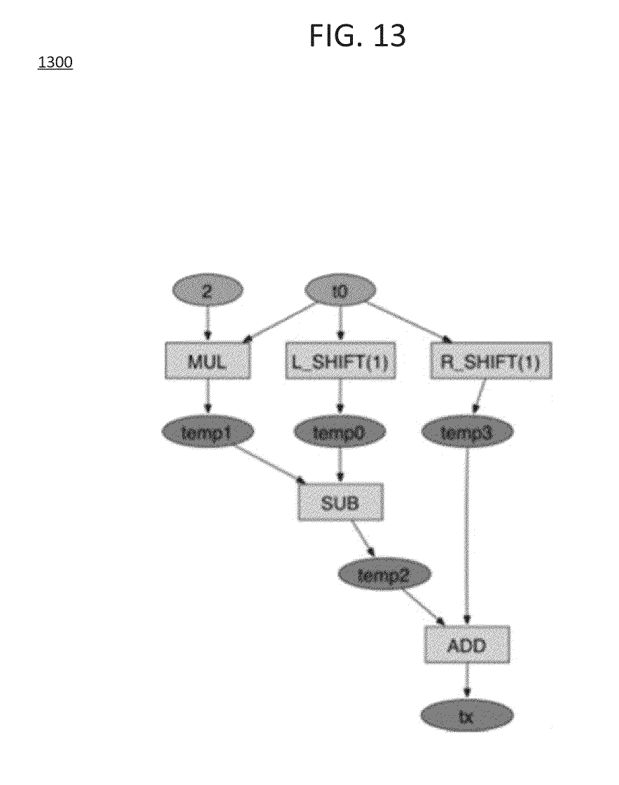

Initially, there is a dataflow graph produced by a data-parallel compiler, such as Scout™. See, for example, FIG. 13. This is a directed graph where square nodes represent operations, such as MUL, L_SHIFT(1), R_SHIFT(1), and oval nodes indicate variables that are produced by the predecessor and consumed by the successor (i.e., subsequent node), or which are available in memory.

Below is an example of a program written in Scout™ to perform a simulation of heat transfer using the finite difference method for a partial differential equation. Some variable declarations are not shown.

### Program

// compute next time-step (Finite Difference)
compute with(shapeof(t0)) {

where(mask [symbol] = 0) { // avoid boundaries...

float tx, ty;
tx = (alpha/(dx*dx))

* (t0[i+1][j] − 2*t0 + t0[i−1][j]);

ty = (alpha/(dy*dy))

* (t0[i][j+1] − 2*t0 + t0[i][j−1]);

t1 = dt * (tx + ty) + t0;

}

}
// display next time-step value
render quad with(shapeOf(t1)) {

image = [symbol] (240 − 240*t1, 1, 1, 1);

}
// t1 becomes t0 for next time-step
t0 = swap(t1); [symbol]
indicates data missing or illegible when filed

FIG. 13 shows a portion of a directed graph that can be generated from dataflow analysis by such a compiler. In FIG. 13, the graph represents an expression from the program shown above. Conventional compiler dataflow analysis may extend to data-parallel languages, for example, to handle the fact that parts of a data-parallel variable may take both paths of a conditional “fork” in the control graph. Note that the variables “i” and “j” in the program represent data-parallel variables that hold the index at all positions for a variable.

A graph 1300, such as that shown in FIG. 13, may be “operated” as a dataflow system using streaming operations with FIFO queues. The same program may operate on all of the nodes of the computing system, potentially with different data on each node. Variables representing local data (e.g. tₒ) may be implemented as processes that stream data from local memory into FIFO queues. Constants (e.g. 2), or other special values may be implemented as computations that produce a stream of values into a FIFO, or as a special FIFO that provides a known buffer of values that can be reused. For computational operators, such as MULTIPLY, SUBTRACT, and ADD, inputs are read from one or more input FIFOs, results are computed using resources available to the node, and results are written to one or more output FIFOs. For distributed operators, such as LEFT-SHIFT and RIGHT-SHIFT, the inputs are made available in router-facing FIFOs (e.g. port group A or B in FIG. 10A), a distributed operation is carried out by one or more router programs, and the results are written by the router program into a router-facing port group (such as port group A or B, of FIG. 10A).

Referring back to FIG. 13, program outputs tx may be implemented as processes that read data from input FIFOs and write it to memory. In some embodiments, implicit operations may move outputs from a router-facing port-group to a memory-facing port group, or vice versa, for example, to assure that complete memory flits are available to processes that move data into memory. An embodiment where the number of FIFO queues cannot accommodate all the variables needed by a program, at a given moment, is analogous to a situation requiring a “register spill” in conventional computing systems, and the graph may be broken up into smaller graphs that write their intermediate results to memory. Operators that become runnable may then read data from memory-facing FIFO queues instead of from the FIFO queues used to connect between operators.

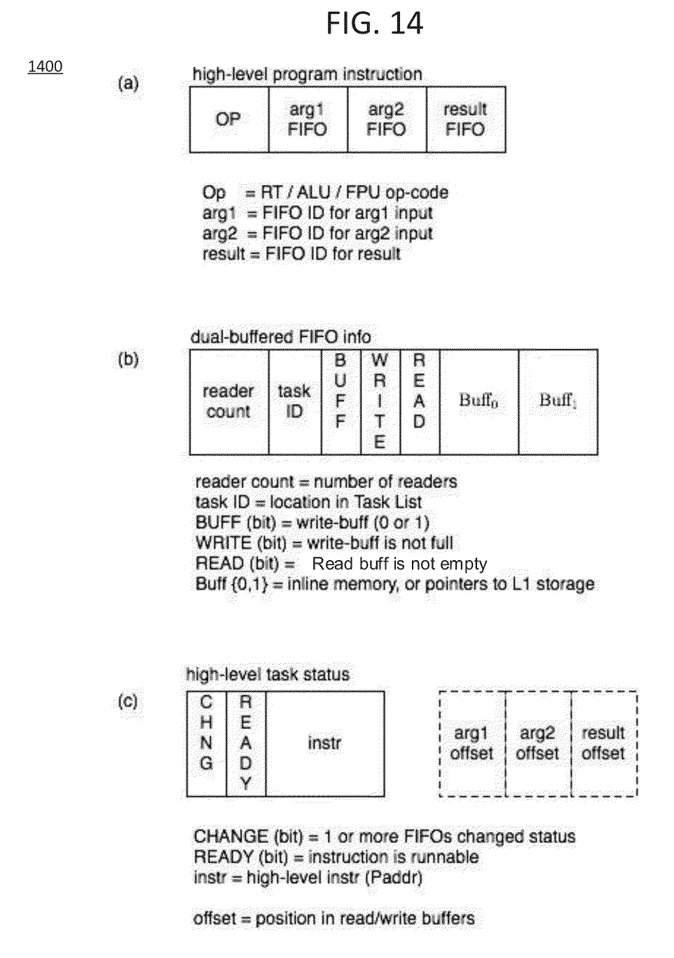

FIG. 14 illustrates data structures 1400 to manage control of the router, compute, and memory operations on a node, according to an embodiment of the present invention. The high-level instruction in section (a) would correspond to one of the operator nodes in graph 1300 of FIG. 13. This would identify an operation and the input and output FIFO queues that provide inputs and receive outputs for that operation. There would be one of these for each node in the graph. There would be a dual-buffered FIFO queue information block in section (b) for each FIFO queue that can be used in a program, corresponding to the initial, intermediate, and final variables, linking the operations in FIG. 13. In this embodiment, dual-buffering is presumed such that each FIFO queue has two buffers, allowing one to be read while the other is being written. Another embodiment may include some or all FIFOs to be implemented as single buffers, operated in circular fashion, in which case there would be additional information needed to manage the current insertion/extraction offset, and the number of values (or, alternatively, the tail-position). BUFF identifies which of the two buffers is for writing. WRITE is asserted if the write-buffer can be written (i.e., is not full), and READ is asserted when the read-buffer can be read (i.e., is not empty). The task-id would refer to a high-level task status entry, as discussed below.

Because a FIFO queue in the embodiment of FIG. 14 is presumed to have the potential of being configured with multiple readers, but only one writer, the embodiment records a count of the number of readers so that the readers can all be assured of having finished with a read-buffer before the buffer roles are swapped by toggling BUFF. The FIFO queue information block would allow updating the READY and/or CHNG flags in the corresponding task status block when one of the FIFO queues associated with that task changes state. Finally, the task status information would allow an executive process to select tasks that are “runnable” (see below).

In some embodiments, if direct memory access (DMA) engines are used to implement streaming memory, as shown, for example, in FIGS. 16 and 17, and the FIFO queue in question is directly associated with memory access, the WRITE flag could indicate that there is room for an entire memory flit, and the READ flag could indicate that an entire memory flit can be supplied. This would allow a DMA scheduler to more-easily identify runnable DMA tasks, as discussed below. In such embodiments, such memory-facing buffers would likely not be circular because all information would be read or written “at once” by a DMA operation. Therefore, it would not be necessary to maintain circular buffer information. Some embodiments could use control structures similar to these to support an emulation of the node behavior in software. However, other embodiments could implement the intent of these structures directly in hardware without need for some of the explicit information. One skilled in the art will readily appreciate that additional information and control structures may be needed, e.g. to support scheduling of router, compute, and/or memory operations, tables of router operations, etc. Further, such additional information and control structures may be implemented in a variety of ways. Several considerations pertinent to scheduling are discussed herein.

In the case where an embodiment has multiple compute engines available on each node, these can generally work concurrently (e.g., performing the multiply, subtraction, and addition of FIG. 13), communicating through FIFO queues, or eliminating explicit FIFO queues in exchange for direct messaging. Computation resources can be placed in support of router operations (for instance, where pairs of input values must be compared to determine their output order) by configuring one set of router-facing FIFO queues (e.g., port A or port B) to supply values to a compute operation, or a graph of operations, to perform the required calculation (e.g., a simple comparison, or something more complex), producing outputs into another set of router-facing FIFO queues (e.g., port A or port B). The outputs may then be used by the router.

The node may track operators that are “runnable”, meaning that they have all of their inputs available and sufficient room to produce outputs. This process may be emulated using hardware components, software modules, or a combination thereof. The node may leave the operator running, asynchronously consuming inputs and producing outputs, and stalling when it is not runnable. A scheduler may have the option of intervening when an operator becomes un-runnable (i.e., running out of inputs or room for outputs), or if some scheduling priority causes the scheduler to prefer another operator. As will be discussed below, multiple operators reading from memory simultaneously may tend to fall into a pattern of execution that allows perfect utilization of memory bandwidth. Therefore, operator scheduling may coordinate with the DMA engines to exploit this.

The execution engine of the node can be described as having a table listing the tasks of a program (i.e., the operations shown in FIG. 13), along with a record of which FIFO queues will be associated with which variables and tasks in the program. This table may be implicit, or may be explicitly generated by a compiler with knowledge of the computing system, allowing optimization to strive toward better organization of the operators and variables.

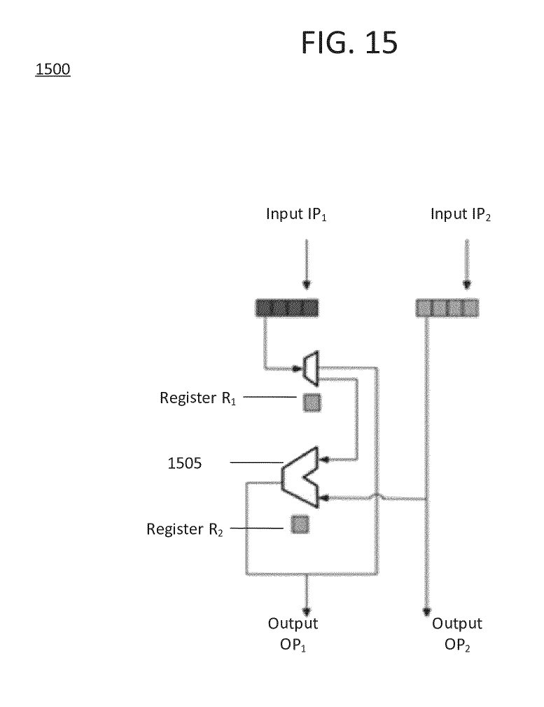

When an operator is determined to be runnable, an actual compute engine or core may be assigned to it, or selected, or the operator may already be resident on the engine or core where it will execute. Because there is a limited set of operators, a value might be set into a register that drives a multiplexer that selects from a set of operations available in the selected compute engine. See, for example, FIG. 15.

For local arithmetic operations, the compute-engine selected for that operator may proceed to iterate as follows: (1) read one value from each connected input FIFO queue; (2) compute a result; and (3) write the result to the output FIFO queue until the result becomes un-runnable or the scheduler intervenes. There can, however, be operators for which each iteration reads multiple inputs and/or produces multiple outputs. For example, an operator could cause an increase in data volume as one input is copied to two outputs of the operator.

For distributed operators, the router receives instructions allowing the router to select the appropriate router algorithm. The router operation may have a similar behavior to the one described above for compute operators. For instance, the router operation may suspend when it is not “runnable”. Router operation may also represent interactions between local memory (or FIFO queues containing locally computed values) and values passing through the router. Router operations in embodiments using TDM-WR may typically be implemented using the principles discussed above, with a coordinated relationship between local memory and the ongoing behavior of a global operation.

From the perspective of ongoing distributed operations passing through a node, runnability is determined in a manner similar to that used for local computational operators, by the availability of data and room for output. Where ongoing local operations have involvement with ongoing distributed operations, it may be important that the ongoing local operations are always runnable, if ongoing local operations are producing inputs, and/or consuming outputs, upon which the runnability of a global operation depends. As was discussed above, the global operators may be designed to make this easier to achieve in that the local memory bandwidth needed for most distributed operators can be reduced in some implementations of TDM-WR. Nevertheless, it is expected that it will be beneficial for scheduling algorithms on the node to give top priority to operators connected to distributed operators so the router will tend to have local values available for sending, and room to write data bound for local memory.

FIG. 15 is a circuit diagram 1500 of a compute fabric, according to an embodiment of the present invention. In this embodiment, the compute fabric includes two input FIFO queues IP₁, IP₂ and two output FIFO queues OP₁, OP₂. Registers R₁, R₂ can be used to configure the flow pattern, and to select an arithmetic operator, respectively. An array of such elements could be structured into a MIN, RMIN, crossbar, or other network topology within each node. The node would then configure the parts of a DFG representing local streaming computations by configuring the operation to be performed at a given compute element (e.g. writing a value in register R₂), and the flow of data to that operator (e.g., writing a value into register R₁). Such an embodiment would allow many lightweight cores to be provided in a single piece of hardware, and to be used flexibly.

If the local compute fabric were also configured as a MIN, data could be scattered and gathered in the same way as was done globally via router functions. Because these cores are operating on streaming data, eliminating some or all of the need for a memory cache, more chip real estate can be devoted to compute engines. Furthermore, in situations where a compute core (above register R₂) is not needed, compute engine 1505 could be powered off, and register R₁ could route past it.

Another embodiment may use the multiple cores of a commodity multi-core processor to perform compute functions using the inter-processor communication facilities of the processor to move streaming data between the cores. Within each core, the mechanisms of, for example, FIG. 14 could be emulated.

Because of the long lifespan of streaming operations relative to the processor clock, and the ability to anticipate periods of time when a core is not needed, power can be saved by shutting cores down when they are not needed. The relatively long lifespan of these operators may also allow cores to be shut down into deeper sleep states than would be possible if it was necessary to keep the cores available for rapid reawakening.

Streaming Memory

To support maximum throughput and to eliminate the need for costly, space-consuming and power-consuming cache, data can be arranged in memory and accessed consecutively in streams. FIG. 16 illustrates an embodiment of streaming memory 1600. Typical dynamic random access memory (DRAM) technology, including synchronous DRAM (SDRAM), requires several delays at various stages of access for reading or writing that are necessitated by the nature of the technology. Other forms of storage may require other delays. DRAM technology typically requires that a physical memory row on a given bank be first activated before it can be accessed. After activation, an address is supplied and data is read or written, but a delay occurs here as well. Further reads and writes can follow without delay, up to a certain maximum. Finally, a delay is needed while the physical row is pre-charged, or closed, before another row can be activated. These delays have the following names

| | |
|---|---|
| tRCD | the delay from ACTIVATE to first READ/WRITE |
| tCAS | the delay from first READ/WRITE to data on the data bus |
| tRP | delay from PRECHARGE to next ACTIVATE |

The specific duration of these delays will vary with the details of the chip, but delays will typically be present. However, on many chips, it is possible to issue commands to one bank while another bank is busy, allowing overlapping operations across banks. See, for example, FIG. 16.

To automatically access all datasets equally well for rows, columns, and/or “shafts” in the third dimension, without programmer involvement, multi-dimensional data may be laid out with logical rows, columns, and shafts intermixed on each physical row of the memory in a regular way, such that each access to a physical row can return approximately the same amount of data from any one of these dimensions, as discussed in relation to FIG. 17. Furthermore, these mixed entries can be scattered across banks such that streaming accesses in different dimensions can proceed regularly across banks, as described below. The process can be driven with a set of DMA engines, or their equivalent, which can perform regular actions, returning approximately the same amount of data, as outlined below:
1. ACTIVATE the target physical row, on the target bank
2. READ/WRITE all relevant physical columns on the activated row
3. PRE-CHARGE close the physical row
4. Compute the next bank/row/columns
5. Indicate ready for dispatch

In some embodiments, the term “logical row” can be used to refer to a row in a 2D array, from a software perspective, and “physical row” can be used to refer to a row of memory in SDRAM. In some embodiments, the techniques discussed herein can be extended to 3D datasets, and beyond. In further embodiments these techniques can be extended to other data-storage technologies. Each physical row can be divided into n consecutive segments, each having size s. With multiple chips, each memory access involves the same address on all chips, making up the width of the datapath, so each segment can be thought of as though the segment contains s full-sized data values, possibly spanning multiple chips. Thus, the term “physical row” may sometimes refer to the same physical row on multiple chips. One skilled in the art will appreciate that such an aggregate physical row will have substantially the same behavior (e.g. delays, burst rates, etc.) as each of the individual physical rows from which it is composed, but with a wider data-path.

While parameters s and n are flexible, parameters s and n may be selected to have values greater than the number of ticks represented in tRCD+tCAS. This follows from the fact that rows in contemporary parts may have 512 to 2048 addressable columns on each bank, depending on the specific model, and tRCD+tCAS may require 4 to 18 cycles, depending on the specific model. Complications resulting from minimum burst rates, and multiple data-rate technologies, are addressed below. Burst-size limitations in some SDRAM implementations force size s to be an even number. Once segment-size (i.e., s) and number of segments (i.e., n) are chosen, the term segment-address can be used to refer to the n segment positions, starting with 0, on a physical bank and row.

FIG. 17 shows a logical view 1700 of an array 1705 having three rows and a physical arrangement of memory 1710, according to an embodiment of the present invention. This example shows a segment size s=16, with n=2 segments per physical row. When storing a logical row, successive segment-sized pieces can be written onto the same segment address of the same physical row, proceeding across SDRAM banks as shown in FIG. 17. When this process has spanned all the banks, it can wrap back to the starting bank, keeping the same segment address and moving to the next physical row (e.g. elements 20-2F, of the first logical row). When the end of a logical row is reached, the process (e.g., DMA process) may have advanced through some number of physical rows. The term “block” can be used to refer to the set of physical rows touched while laying out the first logical row.

For the second logical row of array 1705, the process returns to the bank and physical row on which the first block started, increments the segment address, and proceeds as discussed above. This way, the process can continue to lay out the first n logical rows into the first block. The process then returns to the physical row and bank in which the first block started, increments the physical row by the number of physical rows in a block, increments the bank by one, wrapping to bank 0, if necessary, and begins a new block there.

In an embodiment of the present invention, Direct Memory Access (DMA) engines, or their equivalent, can use this layout scheme to compute and issue a sequence of related memory read or write commands. The read or write may read or write consecutive values from a logical row, and/or logical column, stored in one physical row, as outlined above. Apparent complications that may result from the burst requirements of some multiple-data-rate memory technologies are discussed below. These techniques might be applied to other storage technologies, in addition to SDRAM memory.

It should be appreciated that the choice of size s affects whether row-wise access has a bank conflict at the end of a logical row. This parameter might therefore be implemented as a register value used in DMA address computations, directed from a memory management unit (MMU) that knows the logical dimensions of all variables. Thus, the MMU or compiler may simply select this parameter dynamically to eliminate bank conflicts.

At the end of the first block, the procedure has laid out the n^{th} logical row and advance to the next physical row. This is the beginning of a new block. It should be appreciated that a MMU or other type of computing process may execute the procedure described herein. The procedure can also advance to the next bank, as usual, with the exception that if the procedure is now at the same bank in which it started the previous block, the bank can be incremented by one more. This bank, relative to the bank on which the procedure started the first block (always bank 0, in the description above), is the per-block bank offset. Each successive block can be offset from its predecessor by this many banks. The choice of this parameter affects whether column-wise access will have a bank conflict at the end of a logical column.

Streaming operations, in some embodiments, read and/or write entire variables systematically. As a result, it is possible to anticipate the order of accesses to a variable. This allows exploitation of the memory layout described above, to get the behavior illustrated in FIG. 16. A way of exploiting this layout may be described in relation to a DMA process, or its equivalent, which issues a sequence of low-level commands to memory. Such sequences might be constrained to be structured as outlined above to incur implicit delays of known duration and characteristics at the beginning and end, and moving a sequence of values without interruption from one physical row.

Furthermore, the amount of data moved in such an operation may be similar or identical for accesses that are row-wise, column-wise, depth-wise, etc. The maximum amount of memory moved by such a DMA process could be construed as “memory flit” in some embodiments.

Furthermore, the DMA process can have a known duration, and other characteristics, by virtue of having a standardized interaction with SDRAM. This could allow DMA scheduling to be reduced to a matter of selecting available DMAs based on the bank that a given DMA will access next. This scheduling may also maintain some information about the activation status of the memory banks, and times at which a few previous DMAs began executing.

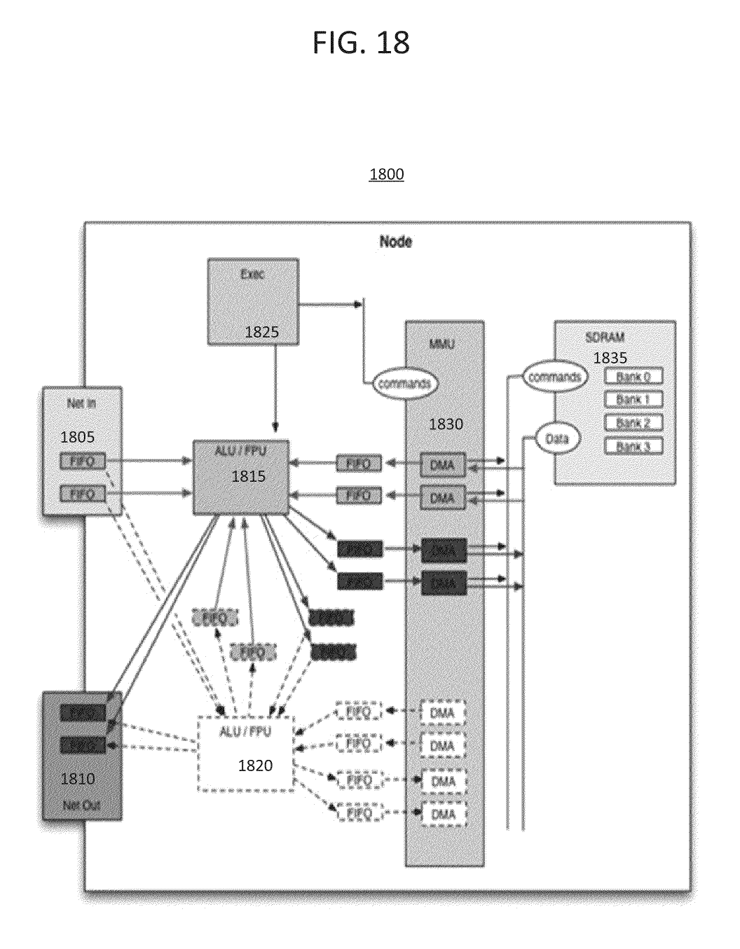

FIG. 18 is a block diagram 1800 illustrating parts of a node other than the router, according to an embodiment of the present invention. The node includes two router-facing input ports (Net In) 1805 and two router-facing output ports (Net Out) 1810. Each set of ports 1805, 1810 includes two FIFO queues. These might correspond with the input and output ports of port groups A and B, in FIG. 10A. An arithmetic logic unit (ALU), or floating-point unit (FPU), 1815 is connected to both sets of ports 1805, 1810, and also connected to another ALU 1820, an executive (e.g., controller) 1825, and a MMU 1830. MMU 1830, which has a plurality of DMAs, is connected to memory (i.e., SDRAM) 1835. Memory 1835 includes a plurality of banks. Memory 1835, has a control channel for commands, and a data-channel for data.

It should be appreciated from the discussion above that the node layout could support efficient streaming access in column-wise, as well as row-wise, order. Referring to FIG. 17, if the node is reading variables in column-wise order, the node may read a single value from the same offset within every segment in the given physical row. These are the values running down a logical column, within the logical rows stored in this block. Then, the node may advance to the next block, keeping the same bank offset used in the first block, relative to the bank where the second block starts.

In principle, a DMA performing column-wise access is not different from a DMA performing row-wise access, though different amounts of data may be involved, depending on the values of s and n. In one embodiment, the DMA performing column-wise accesses may perform one of the following: (1) read two logical columns at a time, and remove one of them; or (2) read two logical columns at a time, and provide them both to software.

In the case of DDR2 memory, DDR3 memory, and other memory technologies, the memory typically does not support accessing individual values in a given command, but rather requires reading or writing a small burst of consecutive values. In the memory scheme of FIG. 17, this would appear to require column-wise and depth-wise accesses to retrieve values for multiple dimensions at a time. However, an embodiment could use multiple memory chips that have smaller individual bit widths, arranged such that the burst reads from each chip are producing successive parts of an individual data value. These reads may be arranged to produce the desired individual values concurrently.

For example, if a burst of 4 values is required by the memory technology, and the embodiment includes 64-bit values, then a memory width of 16-bits would allow one 64-bit value to be read in a burst of four cycles. Concurrent reads from three other 16-bit chips would allow a total of 4 specific 64-bit values to be accessed in 4 cycles, on a 64-bit data-path. This approach preserves the maximization of memory bandwidth through a 64-bit data bus without requiring column-wise or depth-wise accesses to read more than a single value per clock command from respective column-wise or depth-wise dimensions. Similar approaches could be applied to cases with other burst access requirements, data value sizes, and/or data bus widths.

The description above illustrates how a single streaming access can work efficiently. Below is a description of how several DMAs can work together. In some embodiments, a data-parallel program may include a statement with memory semantics analogous to “C=A+B,” where A, B, and C are all two-dimensional arrays. The idea is that corresponding elements of A and B are added, and written to the corresponding position in C. There could be three simultaneous DMAs. By making the FIFO queues connected to DMAs large enough to hold several segments, some of the DMAs may “read ahead”, or lag-behind, in the case of writers. For example, the dual-buffered FIFOs of FIG. 14 could allow this behavior. This gives the scheduler a better opportunity to find a DMA that uses a bank that is not currently active. Using the constrained rules for DMA processes outlined above, only one DMA can actually be moving data at a given time, and another DMA cannot begin on that same bank without waiting for the first to finish pre-charging, and the second may incur the costs of activating a new row. Therefore, if there are 3 DMAs and 4 banks, FIFO queues large enough to hold (n_banks −1) segments, and no bottlenecks in the cores, a scheduler may dynamically schedule the DMAs into a staggered order of bank positions such that one can always be started while another is finishing, as described below.

A DMA can be considered “runnable” if its FIFO queue has enough empty space to receive all of the values it will read, or enough data to supply all of the values it will write.

### A DMA Scheduler Pseudo-Code

| | |
|---|---|
| 01 | repeat forever { |

| | |
|---|---|
| 02 | foreach dma in dma_list { |

| | |
|---|---|
| 03 | if (is_runnable(dma)) { |

| | |
|---|---|
| 04 | schedulable = true |

05

| | |
|---|---|
| 06 | // bank conflict? try to find an alternative DMA |
| 07 | if (dma.bank == busy_bank) { |

| | |
|---|---|
| 08 | if (dma.stifle_count < threshold) { |

| | |
|---|---|
| 09 | schedulable = false |
| 10 | dma.stifle_count += 1 |

| | |
|---|---|
| 11 | } |
| 12 | else { |

| | |
|---|---|
| 13 | dma.stifle_count = 0 |
| 14 | wait(tRCD+tCAS+tRP) |

| | |
|---|---|
| 15 | } |

| | |
|---|---|
| 16 | } |

17

| | |
|---|---|
| 18 | // dma.bank is assured to be ready, if needed |
| 19 | if (schedulable) { |

| | |
|---|---|
| 20 | busy_bank = dma.bank |
| 21 | start(dma) |
| 22 | wait(dma.transfer_size) |

| | |
|---|---|
| 23 | } |

| | |
|---|---|
| 24 | } |

| | |
|---|---|
| 25 | } |

| | |
|---|---|
| 26 | } |

At line 22 of the pseudocode, the DMA scheduler waits long enough for the data to be moved. This means that the next DMA can be started on another bank, tRCD+tCAS, before the current DMA finishes moving data. In lines 7-16 of the pseudocode, the DMA scheduler uses a priority-based scheme to suppress runnable DMAs that would try to access the same bank activated by the current DMA. If a runnable DMA that needs a different bank from the one that is still moving data is being considered, it can be started immediately, allowing the overlap. See, for example, FIG. 15. However, if a runnable DMA that needs the same bank as the current one is being considered by the scheduler, the runnable DMA can be temporarily suppressed while search continues. If DMA scheduling comes back to the one that was previously suppressed, without having found a better candidate, then at line 14 of the pseudo-code, the necessary cost of letting the DMA scheduler finish moving its data can be paid. Then the DMA scheduler can wait for the current row to be closed before starting the new DMA on the same bank.

In the example program “C=A+B,” if all variables start in bank 0, the DMA scheduler would initially have two reader DMAs for A and B, and one writer DMA for C, all targeting Bank 0. The writer will not be runnable as it has no input values, but either reader may be executed. The A-reader may be selected and, when the A-reader is done issuing commands, the scheduler may still have two runnable reader DMAs, with Bank 0 being active. In this example, the B-reader wants Bank 0, which is still active on a different row, so the B-reader would be suppressed. However, if the A-reader wants Bank 1, the A-reader may be scheduled to begin issuing commands at (tRCD+tCAS) memory clock cycles before the data-movement triggered by the previous invocation of the A-reader completes. Now, because the B-reader is runnable on Bank 0 and Bank 0 has finished precharging, the B-reader may be scheduled accordingly. The B-reader may also be scheduled to begin (tRCD+tCAS) before the data-movement due to the second invocation of the A-reader on bank 1 completes. As the B-reader fills its FIFO queue, the ADD operator will have its two streaming operands, and room for output, and may begin producing output into the C-writer's FIFO queue.

When considering whether to schedule the C-writer, supposing that the DMA scheduler does not consider a DMA task runnable until it has a full memory flit available, the C-writer will probably not be runnable until after the A-reader and B-reader read again, because it may not produce a full memory flit of output until then. However, at that point, all three DMAs would be runnable, targeting Banks 0, 2, and 3, with Bank 1 being active. The A-reader, B-reader and C-writer can now run in sequence, chasing each other around the banks indefinitely, without having to stop for SDRAM overhead operations (other than mandatory periodic global refreshes), until, finally, a sequence similar to the start-up is performed in reverse. Setting the value of threshold in the DMA scheduler pseudocode to (n_banks −1) would be adequate to support this scenario.

This approach can be extended to include efficient depth-wise access to 3D datasets, and higher dimensions, while maintaining efficient row-wise and column-wise access, as follows. Consider each step along the z-dimension as touching a new 2D “sheet”, each of which could be laid out in a series of blocks, as described above. Suppose that n is 64, so that there are 64 segment addresses in each physical row per bank. Now, extend the original technique to only use the first 8 segment addresses for the first sheet, the second 8 addresses for the second sheet, and so on. Thus, 8 sheets have been interleaved into each block. This will make each block contain 8 times more physical rows because a logical row can now use ⅛ as many segments in a physical row while having the same total number of segments. However, commands accessing a single physical row can now access 8 elements in a depth-wise direction, as well as row-wise and column-wise, within the same physical row and bank, subject to the same burst considerations as were described in relation to column-wise access. The new sheets-per-block parameter, z=8, along with s=8 and n=64, illustrates that tRCD+tCAS can be hidden for row-wise, column-wise, and depth-wise accesses on a real SDRAM part having at least 512 addresses per physical row and bank. However, these parameters are now much less flexible, and the data moving time for a DMA is smaller, providing less time for scheduling and address calculations.

A person of ordinary skill in the art will appreciate that the amount of memory that is moved to or from memory during each bank access is analogous to a “flit” in the context of routing. This can be used to refer to a standard amount of memory that is pushed or popped from those FIFO queues that interface with memory, allowing the DMA processes to represent a sequence of memory that can be accessed without intervening delays. Ideally, accesses to rows, columns, or shafts would all produce the exact same number of elements, but this may not always work out exactly. In general, a “memory flit” represents the largest size needed to accommodate any of these accesses, as this defines the minimum size for memory-facing FIFO queues, if the memory-facing FIFO queues are to accommodate DMA activities structured as described above. Other FIFO queues in the system could have other sizes, if desired.

This scheme can eliminate the need for memory caching, which is costly in terms of chip complexity, real estate, and power utilization, and which typically demands detailed awareness from programmers. Instead, the streaming model provides maximum memory bandwidth for access to all variables, and eliminates the need for complex cache considerations in programs.

The following is a list of parameter values that might be assigned to individual DMA engines:
DMA start-address (in logical or physical coordinates)
DMA stop-address
logical access-direction (i.e., row-wise, column-wise, or depth-wise)
logical shape (i.e., width, depth, height)
physical start of variable storage (i.e., physical bank, row, and column)
iteration count, with logical stride increment
chain to next DMA
stride to next DMA

In addition, the following information might be available to all DMA engines:
physical memory parameters s, n, z, etc.
number of banks available
tRCD, tCAS, tRP
chip select, if desired

In some embodiments, the DMA engines might be periodically suspended, while a mandatory global refresh of the memory is performed. Some or all of this metadata can be provided to programs, from the DMA engines, to support operators whose output is a sequence of one or more values that can be computed from this data (e.g., certain list comprehensions).

Buffering on Longer or Shorter Links

It should be noted that the “diagonal” links in FIGS. 5-8 appear longer than the “straight” links. Furthermore, these links are longer in lower layers than in upper layers. The folding scheme of FIG. 2 reduces the length of these links, but does not eliminate the effect entirely. The highly orchestrated algorithms that drive the operators (RMIN Routing Algorithms for Scatter and Gather) are designed to operate in this kind of regime, and to accommodate latency wherever it might occur. If data is slow to arrive on any port used in the received actions, the algorithm stalls. The effect on global behavior is that router programs with L-steps operate in a set of system-spanning links that could hold more than L simultaneous values in flight (i.e. the longest latency through all the layers in one direction, including the recurrent links), in some embodiments. These additional values can be thought of as unused multiplexed channels, or potential router-algorithm time-steps, in embodiments that use some variation of time-division multiplexing. This extra capability in the links would be wasted, in some embodiments, but also may be insignificant or tolerable in other embodiments.

For TDM-WR, extra channels can be optimized and exploited as follows. First, additional latency can be added to some or all of the links. For example, some or all of links may be given extra physical length, folded into physical space. In addition, or alternatively, the input queues on ports associated with some or all of the links can be configured to accommodate more values. In this case, the implementation of router command processing is also adjusted so commands that access a set of values from multiple input queues can retrieve a set of values that were transmitted by the appropriately correlated time-steps of router-algorithms on the sending nodes. Furthermore, this adjustment could be configured at start-up time by a distributed operation designed for this purpose, which identifies corresponding input positions on different input queues that represent links to nodes in the same sending layer. To assure that there are an integral number of channels, these factors could be combined to produce latencies on all links that represent an integral multiple of the latency required to transmit individual values, minus the latency of the data movement implemented by a router program instruction, and also minus the latency of the receiving hardware. In some cases, the factors may also be combined such that the latencies on all links between two given layers have the same value. These extensions allow for links traversed on a recurrent trip through all the layers to represent some integral number of router time-division time-steps, M, which is greater than or equal to L (L is the number of layers in an embodiment), such that there are at most K=(M−L) extra time-steps in the longest recurrent-trip through all the layers. The term “recurrent trip” refers to a transit of data around an RMIN embodiment, touching every layer once, arriving back at the starting layer. The term “longest recurrent trip” refers to the physically longest recurrent trip.

Secondly, if M is greater than L, the router programs encountered on any recurrent trip can be extended to collectively represent at least M time-steps. Exposition is simpler for an approach where all algorithms are uniformly extended to L+k time-steps, where k=[K/L], by repeating every time-step in the existing router algorithms k times. All input queues may have to be extended by k additional values. In embodiments that are built on top of a packet-based infrastructure, this approach amounts to requiring packets to have at least k elements, where router programs handle entire packets. The repetition of steps in router programs could be configured automatically, in some embodiments, given a pre-computed value of k, or K and L, via a distributed algorithm at start-up, as described above.

The term “cycle” may refer to an execution of all the time steps in a router program, whether an extended algorithm or not. At the end of each cycle through an extended router algorithm, the last k−1 repetitions of the last instruction may transmit results to local memory, without sending new data onto any output links. Unextended algorithms, may also have steps at the beginning and end of a cycle, or in other places, where this occurs. This can be addressed by allowing the last instructions in the cycle to co-issue with the first instructions of the next cycle, where possible. Router programs in some embodiments may avoid the problem by explicitly co-issuing instructions in specific time-steps, such that usage of the links is maximized.

In embodiments where a router-program scheduler is used and is capable of co-issuing non-conflicting programs, the last step of a router program could be implemented as a separate program made simultaneously executable with the remaining part of the original algorithm. In some cases, the co-issuing capability of the router-program scheduler may separate the scatter and gather phases into separate programs. In embodiments that are built on top of a packet-based infrastructure, router instructions, and elements in input and output queues, may handle or represent an entire block of data at once. In such an embodiment, co-issuing two router instructions could overlap all of their data-movement within the router, without repetition of instructions.

An alternative embodiment may use a scheme other than TDM to allow the layers to share the network. For example, frequency-division multiplexing may be used to match the routing functions to data elements. Where the TDM-WR has deterministic routing behaviors corresponding to data originating from different layers, and identifies those layers based on the time-step in which their data is received, other forms of multiplexing could also have deterministic routing for data originating in different layers, but could match routing function to data elements by other techniques (e.g., the frequency channel in which the data is encoded). This would solve the problem identified above, allowing all layers to transmit at a rate limited only by their memory bandwidth, but could also require the routers to concurrently execute router programs on all channels at once. It should be appreciated that hybrid multiplexing schemes are also possible in other embodiments.

As the network scales, a frequency-division multiplexing approach may introduce new channels with each new layer, requiring greater and greater capabilities in the router of each node. This problem could in turn be handled by increasing the sophistication of router algorithms in a manner corresponding to the extension of TDM-WR algorithms, to be cognizant of M additional routing time-steps. For example, in the case of frequency-division multiplexing, channels could begin to be shared. The operators discussed below could all be adapted to alternative multiplexing schemes.

Operators

The execution environment for data-parallel computational operators was discussed above, including the notion of a compute fabric connected via FIFO queues. A formalism for describing router operations was also introduced, which is extended here to include terminology for the FIFO queues that connect compute engines in the compute fabric. In certain embodiments, the compute engines have access to at most two input FIFO queues, and at most two output FIFO queues. These can be referred to as FIFO_{In0}, FIFO_{In1}, FIFO_{Out0}, and FIFO_{Out1}. In a further embodiment, there may be send and receive queues on the router that have at least length 2. Operator names can be shown in all caps, with the number of inputs and outputs. Capitalized variable names represent streams, whereas lowercase names represent scalar values.

Implementations are shown here for a few data-parallel operators. A vector model can be extended to three dimensions. It should be noted that the operators presented here are by way of example, and other embodiments may include more or less operators, and/or different implementations of at least some of these operators.

Local Operators

Local operators simply receive inputs from one or two FIFO queues and produce outputs to one or two FIFO queues. What distinguishes them from distributed operators is that they do not typically require interaction with a counter to select different behaviors over time, and do not depend on coordination with other nodes. An illustrative set of local operators is described below.
C=ADD (A, B)
C=SUB (A, B)
C=DIV (A, B)
C=MUL (A, B)
C=COMPARE (A, B)

These operators operate pair-wise to combine two input streams of operands into a single output stream of results. A pseudocode description of the behavior is shown below:

| | | |
|---|---|---|
| tᵢ | Recv a/b | from FIFO_{In0} /FIFO_{In1} |

| Compute result = a op b | |
|---|---|
| Write result | to FIFO_{Out0} |

(E, 0)=EVEN_ODD(A)
E=EVENS(A)
O=ODDS(A)

These even/odd operators split a stream into, or select from a stream, the even indexed and/or odd indexed elements starting from 0. A person of ordinary skill in the art will readily appreciate that these operators may imply a single linear stream of input values from which evens and/or odds may be removed. A compiler may determine when calls to EVENS and ODDS can be “fused” into a single call to EVEN_ODD, with one output feeding one consumer and another output feeding another consumer.

| | |
|---|---|
| tᵢ | Recv a from FIFO_{In0} |
| | Recv b from FIFO_{In0} |
| | Write a/b to FIFO_{Out0 /} FIFO_{Out1} |

S=DISTRIBUTE(s)

Instead of actually distributing a scalar value into all of the positions of an array, a “list comprehension” may be used to produce a scalar output for the number of positions that the array would have occupied.

| | |
|---|---|
| Init: | s = 0 |
| tᵢ | Write sto FIFO_{Out0} |
| | s = s + 1 |

I=ENUMERATE(A, dim)

ENUMERATE produces a stream of index values matching some dimension of a variable. The implementation may reach deeper than that of DISTRIBUTE operator above, because an embodiment might maintain information on variable dimensions in the MMU, where it is needed by DMA engines. Therefore, this operator might use meta information provided by a DMA engine (e.g., the width of a dataset), after which the operator could produce a stream of indices as a list comprehension, via a simple arithmetic process. There may also be other useful operators that could make use of general access to DMA metadata about a variable, allowing production of strided indices for permutations of sub-arrays.

Distributed Operators

Distributed operators imply complex network behavior. For example, in some embodiments, the local actions of router programs interact to produce a global effect in data-movement, computation, and/or system configuration. The distributed operators can run on all layers of a RMIN simultaneously, saturating the interconnect without bottlenecks. Distributed operators can also be rearranged in numerous ways to match any shuffle-exchange network topology, as well as other topologies, such as a binary hypercube, or multi-dimensional torus.

The algorithms described herein illustrate that an efficient, stateless, distributed streaming algorithm is possible. For instance, the router may perform actions dictated by a counter to identify the source nodes from which data was sent, and, thus, the appropriate routing operation to perform. In some cases, the algorithm is not only conditioned on the state of a counter, but also depends on the network column and/or row in which the node is found. This latter case can be expressed with conditional pseudocode, but there need not actually be any conditional code at run-time, as one can simply install different unconditional versions of the algorithm on different nodes. This could be done at system initialization time (i.e., by having nodes select which router table is correct based on their network location), by a coordinated network operator that properly installs the appropriate algorithms on the corresponding nodes, or by reference to local variables configured to drive the algorithms appropriately. “Segmented” versions of these operators are perfectly feasible, but will tend to be more complex.
B=SHIFT(A, dimension, shift_amount)

Shifting moves a distributed variable by some given offset in a given dimension, moving parts of the distributed variable across nodes, as needed. Pseudocode for a two-phase implementation is shown below. Multi-dimensional shifts can be created by composing individual shifts.

Values that are logically shifted off the nodes on one edge of the MIN appear shifted in on the opposite edge, yet all nodes in all layers send and receive on both pairs of input and output ports on every clock cycle. Stated differently, the arrival order of values at a node can be configured to carry identification about the source, and one can arrange to deliver those values from different sources in a chosen sequence. Using this approach, a “scatter” phase can be configured such that the sequence of values arriving at a node in the layer where the “gather” phase begins comes from sources selected such that the router algorithm can select over time between alternative routings that would not be routable in combination. This concept may extend to packet switched architectures by storing packets rather than individual values in the router port FIFO queues.

### RMIN TDM-WR for Scatter Phase of a Distributed SHIFT Operation

| | | |
|---|---|---|
| t₁ | Send Local(i)/Local(i+1) | on Bottom_{Left} /Bottom_{Right} |
| | Send Local(i+2)/Local(i+3) | on Bottom_{Left} /Bottom_{Right} |
| t₂ | Recv Top_{Left} / Top_{Right} | as in₀ / in₁ |
| | Recv Top_{Left} / Top_{Right} | as in₂ / in₃ |

| | |
|---|---|
| Send in₀ / in₂ | on Bottom_{Left} / Bottom_{Right} |
| Send in₁ / in₃ | on Bottom_{Left} / Bottom_{Right} |

| t_{3...(L-1)} | Recv Top_{Left} / Top_{Right} | Send on Bottom_{Left} / Bottom_{Right} | |
|---|---|---|---|
| | Recv Top_{Left} / Top_{Right} | Send on Bottom_{Left} / Bottom_{Right} | |
| t_{L} | Recv Top_{Left} / Top_{Right} | as in₀ / in₁ | // turn-around to |
| | | | “gather” |

| | |
|---|---|
| Recv Top_{Left} / Top_{Right} | as in₂ / in₃ |

if ((c mod (W/i)) < 4)

| | |
|---|---|
| Send in₁ / in₀ | on Top_{Left} / Top_{Right} |

else

| | |
|---|---|
| Send in₀ / in₁ | on Top_{Left} / Top_{Right} |

### RMIN TDM-WR for Gather Phase of a Distributed SHIFT Operation

| | | |
|---|---|---|
| tᵢ | Recv Bottom_{Left} / Bottom_{Right} | as in₀ / in₁ |
| | Recv Bottom_{Left} / Bottom_{Right} | as in₂ / in₃ |

if (i = L)

| | |
|---|---|
| Write in₀ / in₁ | as Result[i] / Result[i+1] |
| Write in₂ / in₃ | as Result[i+2] / Result[i+3] |

else if (i == L−1)

| | |
|---|---|
| Send in₂ / in₀ | on Top_{Left} / Top_{Right} |
| Send in₃ / in₁ | on Top_{Left} / Top_{Right} |

else if ((c mod (W/i)) < 4)

| | |
|---|---|
| Send in₁ / in₀ | on Top_{Left} / Top_{Right} |

[symbol]

[symbol]

indicates data missing or illegible when filed

There are two aspects to providing a stream of values that represent a shifted variable: (1) one must access the variable from local memory in an order such that the resulting stream, when matched pair-wise with other streams, will pair elements appropriately (e.g., to pair elements of an unshifted variable with elements of a shifted variable); and (2) one must gain access to the part of the shifted variable that is non-local. In addition, one must choose row-wise, column-wise, or depth-wise access to the local data appropriately. For example, to create the stream for a leftward-shift-by-one, the initial values that would match pair-wise with the initial values of an unshifted variable come from the second column of the local part of the data representing the shifted variable, because the first column is shifted away to the leftward neighbor. Further, the last values of this stream representing the shifted variable would be the first column of data from the variable in the rightward neighbor that have been shifted in from the rightward neighbor.

Unless the shifted result is assigned to a variable, an entire shifted variable does not have to be created in storage. Rather, a stream that has the proper sequence of values can be produced to be matched pair-wise with a sequence of values representing an un-shifted variable. Therefore, when receiving the shifted-in values from a right neighbor, the shifted-in-values can be matched with the first part of the variable from local memory, starting at the second column. The part of the computation utilizing the shifted-in column may be handled as a separate operation, paired with the final column of the un-shifted variable, producing results that represent the tail of the result stream.

It should be noted that a “left-shifted stream” can be provided without delay by starting with the second local column while the distributed operation sends away the first local column and begins receiving the right neighbor's first column. This left-shifted stream, when matched with an unshifted stream beginning in the first column of some other variable (e.g., the result of “2 * t₀” in FIG. 13), allows for efficient streaming “stencil” operations.

In the RMINs of FIGS. 5-8, the latency of the simplest vertical shifts is simply 1, presuming that using half of the available interconnect bandwidth is acceptable. For horizontal shifts, the latency of the network operations, after 2L steps to fill the pipeline, is 2/L because it receives two local values for every L receive operations. However, this implementation uses the full interconnect bandwidth for horizontal shifts. This may lead to tradeoffs that can best be evaluated in relation to a specific application. However, for a dataset with local height H, a horizontal shift of 1 only requires a minimum local size of |2H/L|+2L to avoid all stalls (i.e., to assure the data-movement is complete before it is needed). An implementation of vertical shifts having latency 2/L may be implemented in a similar matter to exploit the full bandwidth.

The examples presented here presume a RMIN, but shifting is different from Binary Swap in that one can conceivably intermix the order of scatter and gather. Therefore, it would be possible to develop similar algorithms for a full-duplex, non-recurrent, shuffle-exchange MIN, e.g., with scatter traveling down-then-up, and gather traveling up-then-down.
B=SCAN(A, sub-operator)

Scan operators (or “parallel prefix” operators) can be implemented as stateless streaming operators in an RMIN, where all layers work simultaneously. Scans may be done with a variety of sub-operators, but the concept of how the sub-operator is applied is consistent. Consider the case of a scan on a stream of values with the addition operator. This may be known as a “plus scan”. One can start with an identity value for the sub-operator in question. For addition, this is 0 because X+0=X. The result of the addition-scan is a stream of values of the form:
output[0]=0, and
output[i]=input[i−1]+output[i−1]

Having an efficient scan operator is useful for constructing a variety of efficient parallel programs. Implementations have been developed for data-parallel hardware in the form of GPUs. However, for a sequence of length k, these algorithms create additional intermediate state data with a size of approximately O(k) during a scatter phase, which is reprocessed into the final result during a gather phase. Two enhancements can be provided: (1) these algorithms are reinterpreted in the context of a streaming RMIN, allowing all state data to travel with the flow of the data, leaving no state behind; and (2) the algorithm is allowed to pass through the different layers of connections in an RMIN in sequential order, starting from anywhere (i.e., wrapping through recurrent links), allowing all layers to participate at once, as has been described elsewhere herein.

Instead of describing all details of an algorithm, the following outlines an algorithm that flows downward from the top layer of butterfly networks such as those in FIGS. 5-8. The algorithm produces results of the first pass in the bottom-most row of FIGS. 5-8. The algorithm also produces the total sum of the sequence in the first position of this intermediate result sequence. Accordingly, instead of running the second pass of the algorithm immediately, the first pass is run on all of the W-wide, distributed sequences, shifting them upwards in the upward vertical links and running the first-pass of the algorithm on the downward links. The algorithm can also spread the “total sum” produced by each such pass upward on the upward diagonal links, distributing them in an orderly fashion. When all the first passes are completed, before moving to second passes, the algorithm performs complete up-and-down passes on the “total sum” values, as though they were a distinct set of distributed sequences. The result is a scan of the sums of the individual sequences. This scan-result can now be used in the downward passes of all the individual sequences, allowing them to produce a final global scan result.
B=SORT(A)
B=PERMUTE(A, INDICES)

The following describes several approaches to providing a sort operator, mentioning two requirements that could be added: (1) adaptation for the streaming architecture in which all layers of a MIN are active simultaneously, as was seen with other examples, above; and (2) support for “out of core” dataset sizes. In general, it should be noted that the dataset being sorted may have a large extent on every node. Where the extent on each node varies, one of ordinary skill in the art would appreciate that an early load-balancing pass could be performed in which values are moved unevenly in the machine so that the rest of the operator works with roughly uniform quantities of local data on every node.

Ordered passage through a growing set of the stages of a shuffle exchange MIN, as shown in, for example, FIGS. 5-8, can perform a Bitonic Merge sort on sets of individual values. For instance, from Layer2 of FIG. 5, one value at each node could be duplicated onto both upward links. This can be referred to as the beginning of the first sort process. Certain pairs of nodes in Layer 1 would receive the same pair of values. The same pair of values are compared at both nodes, and in the left-most pair of nodes in the top layer, the node in the lower-valued column maintains the lower of the two values, while the node in the higher-valued column maintains the higher of the two values. In the other pair of nodes in the top layer, the node in the lower column maintains the higher value. The values along the top nodes in FIG. 5, for example, now represent a bitonic sequence, but in larger networks this may be a set of bitonic pairs.

The values along the top node may then pass straight down the column links to the third layer. This is the second stage of the first sort process. The values are again duplicated on each of the upward links to the second layer, and pair-wise compared. This time the comparisons are performed the same in both pairs of receiving nodes (e.g. keeping the lower value in the node in the lower-numbered column). The results in the second layer may then be duplicated on each of the upward links, again producing pairs of values at each of the nodes in the top layer. This time, the comparisons at the top layer is performed the same in both pairs (e.g., keeping the lower value in the node in the lower-valued column). In general, for networks of arbitrary size, this algorithm passes first through the top set of links, then the top two sets of links (after travelling down the columns), then the top three sets of links, and so forth, until it has started at the bottom and travelled upwards through all the sets of links. The result is values across the nodes of Layer1, representing a sorted list of length W.

Where the process described above began in Layer2, moving toward Layer1, an analogous process could begin at Layer3, moving toward Layer2. This can be referred to as the beginning of the analogous sort process. At each point when the process described above is duplicating data on upward links, the analogous process could be moving data on upward links, one layer lower. When the process described above is moving data on downward column links, the analogous process could be moving data on downward links, one layer lower. The analogous process would use the recurrent links, where appropriate, but would treat these as a no-op, and then go one layer further. The result after completing the entire process analogous to the first sort process would not be a sorted sequence across the nodes of Layer2, but rather a sequence that could be mapped to a sorted list, by renumbering the nodes. Alternatively, the sequence can be moved through one layer of the RMIN to produce a sorted sequence. In general, as many analogues of this process as there are layers can operate concurrently. In addition, concurrent versions of these processes can work concurrently in the opposite direction.

For instance, if local data is fed from each node in a layer, repeatedly into any of the sort processes described above, the results could be collected into a column in each node. In this column, the successive elements stand in relation to the corresponding elements in the results columns of other nodes (i.e., other nodes in the same layer) as elements in a W-wide sorted sequence. Several approaches, noted below, might be used to merge these smaller sequences into larger sequences, eventually arriving at a global sort.

First, by alternating the sense of comparisons used in successive iterations of either of the sort processes described above, consecutive W-wide sequences across the results columns in the nodes in the results layer can be made to represent sequences that are alternatively ascending and descending. Consecutive pairs of these ascending and descending sequences can be treated as 2 W-wide bitonic sequences that are present pair-wise on the same nodes. Local processing at the node can then perform the same function on these pair-wise parts of the bitonic sequences, which was performed by the links between Layer2 and Layer1, in the beginning of first sort process. This time the pair is sorted ascending on even nodes, and descending on odd nodes.

If, for example, the first sort process is performed again, starting from Layer2 to Layer1, passing members of these pairs is effectively performing the second stage of the first sort process, rather than the first stage of the first sort process. This is due to the local processing allowing the single physical network to be treated as pairs of virtual networks, with local processing emulating an additional layer of physical nodes, connecting the two virtual networks. As the merged distributed result sequences go from 2W to 4W to 8W, the local processing load will increase, as more and more of the comparisons are performed locally. However, at some point these local tasks may be transposed across a row, as described below, to make use of the physical network.

In an alternative embodiment, multiple W-wide sorted sequences may be made local to different nodes using, for example, the TRANSPOSE operator, outlined below. Local processing can then merge pairs of locally-resident bitonic sequences.

PERMUTE operator can be built on top of a sort operator, where each value in a sequence is associated with the globally unique index of its destination position. The indices are sorted, bringing the values along with their indices. This is achieved by assuming at every point in the routing algorithm that there are two values arriving and departing in sequence at each port. The first is treated as a regular sort, and the second is “inert”, following the first. Globally unique indices can be created from a locally unique index by prepending the node row and column as the high-order bits of the index. Where a partial ordering is sufficient, the indices need not be globally unique.
b=REDUCE(A, operator)

Reduction operator is the process of combining all of the values in a data-parallel variable under some given operator to produce a scalar. For example, a reduction could be used to find the maximum value in a dataset. Easily supported operators include MIN, MAX, ADD, SUBTRACT, MUL, DIV, etc. One skilled in the art will readily appreciate that the binary swap and extended binary swap algorithms, applied to image compositing, are an element-wise reduction of a set of images using MAX of the depth-position attribute of two pixel values as the operator. The result is an image distributed to all nodes in the row. However, the result of a compositing operation is only part of what a generalized reduction operator should do. The reduction operator should produce a single final value in all nodes, which is the maximum (e.g., in the case of MAX) of all values in all the local copies of parts of a variable, in all nodes across the system.

In general, reduction operations is performed locally to reduce the amount of work required for distributed reduction. Thus, a balanced approach would be tuned to a specific embodiment. However, one implementation may include a global reduction of part of a dataset, while concurrently performing a local reduction of the rest of the dataset. The local and distributed portions would be selected such that the two processes would complete at the same time, resulting in two values at every node, e.g., one locally computed and one globally computed. The locally computed value and one globally computed value would be reduced to a single local value, and then a final distributed pass would provide a single global value at all nodes.
CHECKPOINT( )
RESTART( )

In order to provide reliability, certain embodiments may provide a distributed CHECKPOINT operator to copy local memory from all nodes to another place. If a node fails in the system, another node can be provided to take its place and a RESTART operator can be used to reload the state that was previously saved, into all nodes, so that the global computation may resume. Some embodiments may use external links, such as those of FIGS. 5-8, to write state to external storage. Certain embodiments may also use the RMIN network to copy or encode the local state of each node into local memory of other nodes. Because of the support for streaming memory in some embodiments of RMIN, the latter choice may allow for much faster implementations. This is important as computing systems reach very large scales, because increasing the number of nodes implies decreasing the mean time between failures (MTBF) of the system as a whole.

Some embodiments may reach scales at which the time needed for a checkpoint to external storage would exceed the MTBF. Some embodiments may have reserve nodes available. Upon detection of a node failure (e.g., using IPMI), a substitute node may be found manually or automatically for the failed node, and a RESTART could be triggered manually or automatically. This would allow for reloading of a state into all nodes (including the replacement), and resume the computation where it was at the last CHECKPOINT. The scheduling of checkpoints and restarts could be controlled automatically, requiring no effort from programmers to capture all of the states of their computation. Checkpointing to the memories of other nodes could be performed as follows. Notice that this example presumes four router half-instructions per time-step, rather than two. Here, both FIFO queues on both the transmit and receive ports are used simultaneously, on both the Top and Bottom port groups. This presents no challenge for an embodiment with full-duplex links.

### RMIN TDM-WR for a Distributed CHECKPOINT Operation

| | | |
|---|---|---|
| tᵢ | Send Local(i)/Local(i+1) | on Top_{Left} /Top_{Right} |
| | Send Local(i+2)/Local(i+3) | on Bottom_{Left} /Bottom_{Right} |
| | Recv Backup(i)/Backup(i+1) | on Top_{Left} /Top_{Right} |
| | Recv Backup(i+2)/Backup(i+3) | on Bottom_{Left} /Bottom_{Right} |

The example above presumes that there is a special memory region used to save a copy of all the memory used by programs. Although not shown, there may be an operation to save the state of processors and routers within a node in such a way that would allow restoring a coherent global state, and saving this information along with local memory. If the state-saving operation would first write this information into local memory, then copying all of local memory would be sufficient.

Certain embodiments may use Reed-Solomon encoding, or some other technique of encoding local memory, as part of a checkpoint operation, with the corresponding decoding operation to become part of the restart operation. This could be supported with hardware implementations of Galois multiplication or other mathematics needed for the encoding/decoding. Where these operations produce multiple outputs, the example router code above could be extended to scatter these multiple results to different nodes. The corresponding RESTART would then retrieve the encoded information from the designated nodes, perform the decryption, and reload the resulting state. Where distributed implementations of encoding and decoding were provided, these could be used to support the checkpoint and restart.
B=FFT(A)

The shape of the “butterfly” network that has been used as an example is naturally amenable to supporting a Fast Fourier Transform (FFT). There already exist efficient parallel implementations written as data-parallel programs. In order to provide maximal throughput such that the FFT can run from all layers at once, as has been done with some other operators, one can add concurrent FFT implementations to combine the terms of the FFTs (originating from different layers) in different orders. This may have undesirable numeric consequences in some cases, and may be unnecessary in others. In some embodiments, FFT is provided as a built-in operator, especially if it could be “fused” with a TRANSPOSE to provide more-efficient multi-dimensional FFTs.
B=TRANSPOSE(A, source-dimension, destination-dimension)

An efficient TRANSPOSE operator can invite certain kinds of high-throughput applications. For example, high-throughput external I/O, combined with efficient one-dimensional FFTs and the availability of an efficient transpose operator, will support high-throughput multi-dimensional FFTs. The fact that one can access local rows and columns (and “shafts”) with equal efficiency, infers that one can avoid bottlenecks in the TRANSPOSE operator where both modes of access must be used simultaneously.

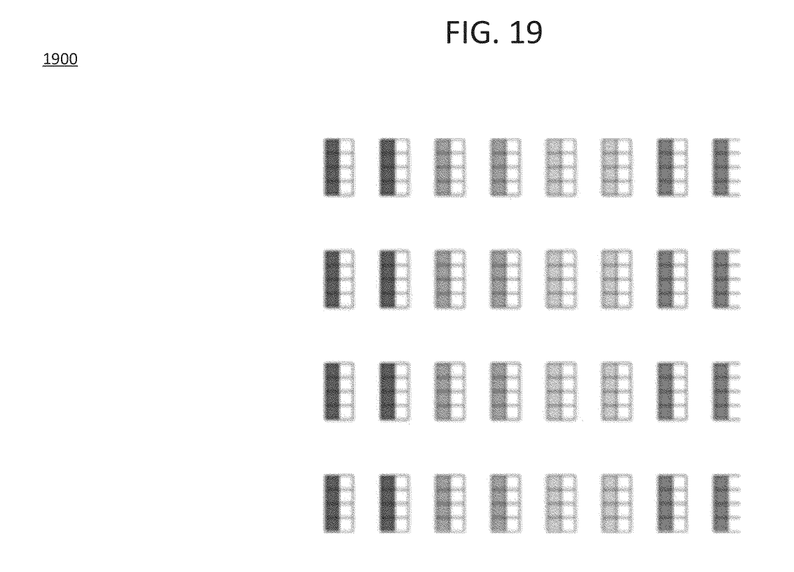

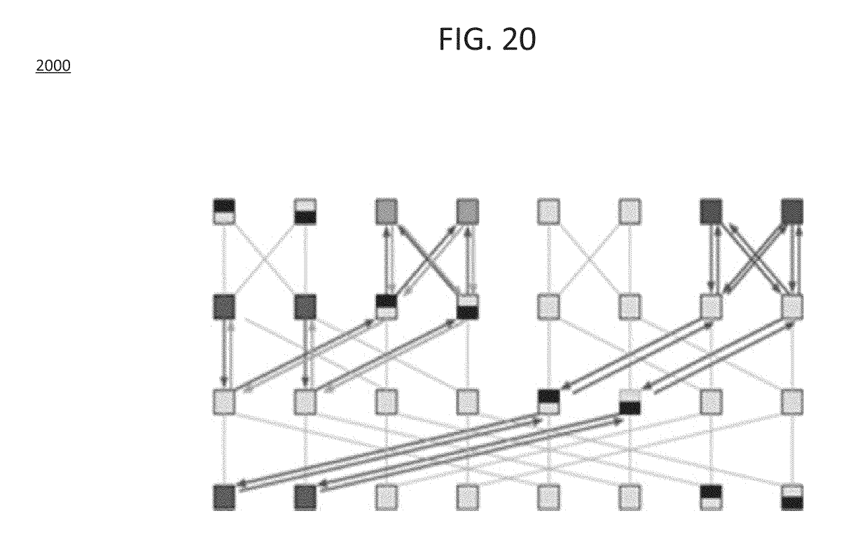

For illustration, assume that there is a 2D variable that has a 2D extent on every node in the computing system, and that the dimensions are some multiple of the inverse of the ratio of W/L. See, for example, FIG. 19. Also, one can make the simplifying assumption that there is an even number of layers in the MIN. For the XY transpose, values in global (row, column) positions move to (col, row). See, for example, FIG. 20.

Certain embodiments of the present invention pertain to a specialized MIN for performing general-purpose computation, based on distributed data-parallel operators which orchestrate motion of data through the machine. A scheme for organizing storage of variables allows efficient streaming access to any dimension of multi-dimensional variables, and avoids the need for caching of data.

The machine may be organized with many discrete processing elements connected like the components in a Multi-stage Interconnection Network (MIN). The nodes form “layers”, with each node having two ports facing each of the two neighboring layers for a total of four ports per node. All four ports can be full-duplex, and the two directions can be treated as separate virtual networks. Recurrent links can be present from the “last” to the “first” layer. Many aspects of the design can be implemented in a half-duplex MIN with recurrent links, or in a full-duplex MIN without recurrent links. Data can originate, terminate, cross virtual networks, interact, or be modified at each node layer in the MIN. It is possible for data to move continuously through the MIN without bottlenecks, and to be continuously added and/or removed.

Nodes can perform both routing and computation. Several patterns of global routing behavior are identified above, allowing for continuous movement of data on all links in the network simultaneously, and resulting in certain useful global effects. Some of these global “operators” achieve effects that have been described, analyzed, and implemented. Some other operators are added such as Transpose and FFT. MINs may be described as forming a basis for computation, and iterative networks may support useful computation. A general purpose machine is described herein, with a full complement of useful operators that can be constructed recursively and operated with considerations for power efficiency, reliability, and throughput.

Variables will typically be stored across the entire system with logically-contiguous portions of width, breadth, and/or depth being resident on the same node. Within each node, the local portions of a variable are laid out in memory in such a way that any dimension of the local part of the variable may be accessed continuously, traversing banks of the memory as needed, without incurring delays (e.g., tRCD, tCAS, and tRP delays). A set of DMA engines moves portions of these data “streams” between memory and a set of FIFO queues that are sized to accommodate the amount of each variable that is stored in a single bank and row.

Local computation may take several forms. Most prominently, one or more streaming kernels may be identified by a compiler. Each kernel includes a series of operators and associated input and output variables, as would be found in the DFG of a compiler or a sub-graph thereof. These operators are identified with one or more physical compute elements within each node, and FIFO queues are configured to supply the inputs and receive the outputs. As long as there are inputs available and room for outputs, the operator acts, consuming inputs and producing outputs. The technologies can implement a Kahn Process Network (KPN), and implement functionalities of Petri Nets. Data is thus “pipelined” through the implemented portion of the DFG. At each step, multiple operators may by receiving inputs from their “upstream” graph neighbors and producing outputs to be consumed by their “downstream” graph neighbors.

In some embodiments, local computation may permute or shuffle data-streams to carry out the prescribed orchestration of flows entering and leaving the node so as to support distributed operators. These flows may be originating from local memory, passing through the node from external sources and destinations, and/or arriving to become resident in local memory.

New data-parallel operators can be created using a low-level machine code that drives the router in each node over the course of each “operator”. This machine code for a given operator can comprise a series of individual routing steps. There is also a TDM-WR switching allowing global operators to be written in simple local terms since the movement of data through the global network maintains an ordered relationship.

The machine is amenable to concise high-level data-parallel/streaming/functional programming languages in which a programmer can invoke the efficient global operators without having to describe their behavior. The high-level machine code is compiled to a DFG and mapped to resources by the compiler. The steps of the program then invoke the data-parallel operators. Those operators with a distributed action (i.e., moving data in the global network) may be defined in router microcode, and could therefore be improved or extended without altering the machine.

Some embodiments pertain to scheme for the layout of data in a multi-bank memory, so that width, breadth, and depth of a dataset can be accessed (e.g., read or written) with equal speed in a continuous stream without incurring those delays inherent in conventional SDRAM memory technology, commonly referred to as tRCD (RAS to CAS delay), tCAS (Column-Address Strobe latency), and tRP (RAS pre-charge delay).

Development of a TDM-WR switching allows arbitrary numbers of virtual circuits to share the same physical link without the need for increasing amounts of buffer space or support hardware. Design for a composite Router/Compute node in arbitrarily-sized RMIN, including details of router microcode allowing development of global dataflow operations in the RMIN using only local control and a fixed number of “flit”-sized buffers. Data can be pipelined from memory through a configurable compute fabric and back to memory. Data can also be pipelined in an orchestrated way between local memory and router ingress/egress ports, allowing efficient streaming global operators without need for conditional code.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A scalable apparatus, comprising:
a plurality of layers, each of the plurality of layers comprising a plurality of nodes;
a plurality of links configured to connect each of the plurality of layers; and
a plurality of recurrent links configured to connect a plurality of nodes in a last layer of the plurality of layers to a plurality of nodes in a first layer of the plurality of layers, wherein
the plurality of links, together with the plurality of recurrent links, are configured to allow data originating in any layer of the plurality of layers to pass through each of the plurality of layers without interruption.

2. The scalable apparatus of claim 1, further comprising:
a gap between each of the plurality of layers, wherein the gap is configured, as a function of scale or layer number to foster movement of air or another cooling agent through the scalable apparatus.

3. The scalable apparatus of claim 1, further comprising:
spacing between a plurality of sub-networks, wherein the spacing is configured as a function of scale or layer number to foster movement of air or another cooling agent through the scalable apparatus.

4. The apparatus of claim 1, wherein each of the plurality of nodes is configured to perform a same amount of local work and/or to move a same amount of data, thereby avoiding delays.

5. The apparatus of claim 1, further comprising:
a plurality of multiplexors, wherein each of the plurality of multiplexors is associated with one of the plurality of recurrent links and is configured to split, merge, and/or redirect streams of data.

6. The apparatus of claim 1, wherein each of the plurality of nodes are configured to operate as a router during a distributed data moving operation beginning at any of the plurality of layers.

7. The apparatus of claim 1, wherein
the plurality of links comprises a plurality of shorter links and a plurality of longer links and/or the shorter links comprise extra length to match the corresponding longer links such that data flows to each node in a simultaneous manner, and
a plurality of transceivers associated with shorter links is configured to add a specific amount of delay.

8. A node, comprising:
a plurality of input ports and a plurality of output ports; and
a router configured to select a routing algorithm to move data elements from at least one of the plurality of input ports to at least one of the plurality of output ports based on identifying information related to a source node within a context of a distributed routing operation designed to have a specific global effect.

9. The node of claim 8, wherein the identifying information related to the source node comprises a counter in the router representing Time-Division-Multiplexed time slots, where data from and/or to specific ports is received and/or sent.

10. The node of claim 8, wherein the identifying information related to the source node is based on any multiplexing technique in which the routing function can be implicitly matched to the appropriate data simply by matching the routing function to a multiplexed channel.

11. The node of claim 8, wherein each of the input ports comprises a queue for receiving that is configured to permit access the plurality of the data elements,
each of the output ports comprises a queue for transmission, and the node further comprises associated circuitry and/or instructions configured to execute commands to select and transfer a specific combination of one or more of the plurality of data elements from accessible input positions in the queue of an input port, and to transfer the one or more of the plurality of data elements to an output queue of an output port.

12. The node of claim 11, wherein at least some of the plurality of input ports and the plurality of output ports are combined into port groups, and
the commands are configured to select and transfer a specific combination of data elements in a plurality of accessible input queue elements of the input queues of the ports in an input port-group, and transfer the specification combination of data elements to the plurality of queues in the output ports in an output port-group.

13. The node of claim 8, wherein the node further comprises a program counter configured to control a router algorithm counter, the router algorithm counter configured to cause the data elements to move from an interconnect to a compute fabric and from the compute fabric to the interconnect.

14. The node of claim 12, wherein the compute fabric is connected to memory by queues allowing values to be added to one queue while another queue is consumed.

15. The node of claim 8, further comprising:
an executive configured to select an operator and a set of router-facing queues, and to attach the router facing queues to a specific set of compute elements to perform a supporting arithmetic calculation.

16. The node of claim 8, further comprising:
a memory management unit comprising a plurality of domain memory access (DMA) engines configured to operate in a series of time slices, wherein each of the plurality of DMA engines is configured to issue a sequence of memory commands that imply a continuous stream of data moving to or from memory with delays incurred only before or after the movement.

17. The node of claim 16, further comprising:
a direct memory access (DMA) scheduler configured to support scheduling of the plurality of DMA engines into a staggered order, when feasible, such that the initial and final delays incurred by one DMA engine may occur while data is moving on behalf of another DMA engine.

18. The node of claim 8, further comprising:
memory comprising a plurality of banks, and an arrangement of data within each of the plurality of banks, such that width, breadth, and/or depth of a dataset can be accessed with equal speed in a continuous stream without incurring delays.

19. The node of claim 8, wherein the plurality of links comprises a plurality of additional wires, bits in data communicated on the plurality of links, and/or extra multiplexed channels to be used for out-of-band control signals, representation of “not-a-value” data elements, and/or diagnostic information.

20. The node of claim 8, wherein the identifying information related to the source node comprises explicit information comprising a packet header.
